(19) United States
(12) Patent Application Publication
(10) Pub. No.: US 2026/0323736 A1
(43) Pub. Date: Oct. 15, 2026

(54) METHODS FOR ENHANCING AIML APPLICATION TRAFFIC OVER D2D COMMUNICATIONS

(71) Applicant: InterDigital Patent Holdings, Inc., Wilmington, DE (US)

(72) Inventors: Ulises Olvera-Hernandez, Saint-Lazare (CA); Chonggang Wang, Princeton, NJ (US); Samir Ferdi, Kirkland (CA); Xu Li, Plainsboro, NJ (US); Robert Gazda, Spring City, PA (US); Jung Je Son, Warrington, PA (US); Achref Methenni, Montreal (CA); Morteza Kheirkhah, London (GB)

(73) Assignee: InterDigital Patent Holdings, Inc., Wilmington, DE (US)

(21) Appl. No.: 19/119,031

(22) PCT Filed: Nov. 3, 2023
(86) PCT No.: PCT/US2023/078589

§ 371 Date: Apr. 7, 2025

Related U.S. Application Data
(60) Provisional application No. 63/422,310, filed on Nov. 3, 2022.
(60) Provisional application No. 63/452,878, filed on Mar. 17, 2023.
(60) Provisional application No. 63/583,393, filed on Sep. 18, 2023.

(51) Int. Cl. H04W 76/14; H04W 4/02; H04W 8/00; H04W 88/04

(52) U.S. Cl. CPC H04W 76/14; H04W 4/023; H04W 8/005; H04W 88/04

(57) ABSTRACT

A first wireless transmit/receive unit (WTRU) may trigger a proximity services (ProSe) discovery procedure indicating an application operation mode and/or ProSe capabilities. The first WTRU may discover artificial intelligence machine learning (AIML) application assistance services. The Prose capabilities may include one or more AIML application assistance services associated with at least one of data storage, data processing, and/or data aggregation at one or more peer WTRUs and/or relay WTRUs. The first WTRU may generate discovery codes based on the AIML application assistance services indicated by the peer WTRUs and/or relay WTRUs during the ProSe discovery procedure. The first WTRU may select a second WTRU from the peer WTRU(s) and/or relay WTRU(s) based on the discovery codes. The first WTRU may trigger ProSe direct communications with the selected second WTRU to enable the first WTRU to connect to the second WTRU for providing the one or more AIML application assistance services.

### CROSS-REFERENCE TO RELATED APPLICATION

This application claims priority to U.S. Provisional Patent Application No. 63/422,310 filed on Nov. 3, 2022, to U.S. Provisional Patent Application No. 63/452,878 filed on Mar. 17, 2023, and to U.S. Provisional Patent Application No. 63/583,393 filed on Sep. 18, 2023, the entire contents of each of which are incorporated herein by reference.

### BACKGROUND

3GPP 5G Systems may fail to support features imposed from the specific traffic characteristics that AIML operations running on 3GPP networks may include.

### SUMMARY

One or more Prose-based AIML application traffic embodiment(s) are described herein.

Prose Provisioning, Discovery and/or Direct Communications supporting Volunteering operations are described herein.

A Prose provisioning mechanism that associates performance indicator to application traffic characteristics and/or volunteering services (e.g., services that enable WTRU to perform store and forward data and/or process and forward data, and/or aggregate and/or forward data) are described herein.

A Prose Discovery mechanism that generates discovery codes based on the volunteering services provided by a peer WTRU and/or a relay WTRU are described herein.

A Prose Direct Communication mechanism that enables WTRU performing as volunteering-consumers to connect to other WTRU performing as volunteering-providers by using discovery codes associated to AIML traffic characteristics are described herein.

An associated Destination Layer-2 information element to enable WTRU to operate as store and forward and/or process and forward and/or a Layer-3 Relays are described herein. A volunteering-consumer WTRU may be a WTRU that uses the services from another WTRU (e.g., volunteering-producer WTRU), that may offer additional functionality beyond point-to-point connectivity and/or beyond WTRU-to-Network relay. For example, this type of functionality may be storing and forwarding information and/or processing and forwarding information.

One or more extensions to quality of service (QoS) monitoring procedures to enable application function (AF) to request QoS monitoring (e.g., also) for connection(s) for PC5 links may be described herein.

A first WTRU may trigger a proximity services (ProSe) discovery procedure by indicating an application assistance operation mode and one or more ProSe capabilities. The application assistance operation mode may be associated with one or more AI and/or ML applications. The first WTRU may be configured to discover one or more artificial intelligence machine learning (AI/ML) application assistance services. The one or more ProSe capabilities may include the one or more AI/ML application assistance services associated with at least one of data storage, data processing, and/or data aggregation at one or more peer WTRUs and/or one or more relay WTRUs. The first WTRU may generate one or more discovery codes. For example, the first WTRU may generate one or more discovery codes based on the one or more AI/ML application assistance services indicated by the one or more peer WTRUs and/or the one or more relay WTRUs during the ProSe discovery procedure. The first WTRU may select a second WTRU from the one or more peer WTRUS and/or the one or more relay WTRUs. For example, the first WTRU may select a second WTRU from the one or more peer WTRUS and/or the one or more relay WTRUs based on the one or more discovery codes. The first WTRU may trigger ProSe direct communications with the selected second WTRU to enable the first WTRU to connect to the second WTRU for providing the one or more AI/ML application assistance services.

Triggering the ProSe discovery procedure may include the WTRU configured to send a solicitation message to the one or more peer WTRUs and/or the one or more relay WTRUs. The WTRU may send the solicitation message using the one or more discovery codes. The solicitation message may request a first ProSe capability of the one or more ProSe capabilities. The solicitation message may indicate one or more of: a ProSe application identifier, an operation mode, and/or metadata associated with the operation mode.

The WTRU may receive a response message from the one or more of: the one or more peer WTRUs and/or the one or more relay WTRUs. The response message may indicate that the respective WTRU is configured to perform the first ProSe capability requested in the solicitation message. The first ProSe capability may include store and forward and/or process and forward. Selecting the other (e.g., second) WTRU may be based on response message indicating the first ProSe capability.

Triggering ProSe direct communications may include the first WTRU being configured to send a ProSe direct communication request to the second WTRU. The ProSe direct communication request may indicate an intent to use the first ProSe capability via the second WTRU.

The first WTRU may send a provisioning request that indicates the one or more ProSe capabilities. The provisioning request may include one or more of: a helper service code, a user information identification, an operation mode, and/or one or more quality of service (QoS) characteristics. The first WTRU may receive a QoS monitoring request that indicates to monitor one or more application traffic characteristics associated with the application assistance operation mode and/or the one or more ProSe capabilities. The first WTRU may send a QoS monitoring response that indicates one or more QoS monitoring results associated with the one or more application traffic characteristics.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of an artificial intelligence (AI)/machine learning (ML) model downloading over 5G System (e.g., model distribution).

FIG. 3 illustrates an example of AI/ML download from a volunteering WTRU.

FIG. 4 illustrates a flow diagram that depicts an example procedure for a network function (NF) to retrieve the computation-integrated Proximity Services (ProSe) capability of a given WTRU (e.g., a relay WTRU and/or a remote WTRU).

FIG. 5 illustrates a flow diagram that depicts an example procedure for a NF to subscribe on the one or more change(s) to the computation-integrated ProSe capability of a given WTRU (e.g., a relay WTRU and/or a remote WTRU).

FIG. 6 illustrates a flow diagram that depicts an example procedure for a NF to retrieve the authorized computation-integrated ProSe capability(ies) of a given WTRU.

FIG. 7 illustrates a flow diagram that depicts an example procedure for a NF to discover a relay WTRU with the authorized computation-integrated ProSe capability(ies) that may be within the proximity of a given WTRU.

FIG. 8 illustrates a flow diagram that depicts an example ProSe Parameter Provisioning.

FIG. 9 illustrates a flow diagram that depicts an example ProSe Discovery Request (e.g., Model B).

FIG. 10 illustrates a flow diagram that depicts an example ProSe Direct Communication supporting volunteering functionality.

FIG. 11 depicts a flow chart diagram illustrating an example of quality of service (QoS) monitoring for PC5 links.

FIG. 12A is a schematic illustration of an example system environment that may implement an artificial intelligence (AI) and/or machine learning (ML) model.

FIG. 12B illustrates an example of a neural network.

FIG. 12C is a schematic illustration of an example system environment for training and/or implementing an AI/ML model that includes a neural network (NN).

### DETAILED DESCRIPTION

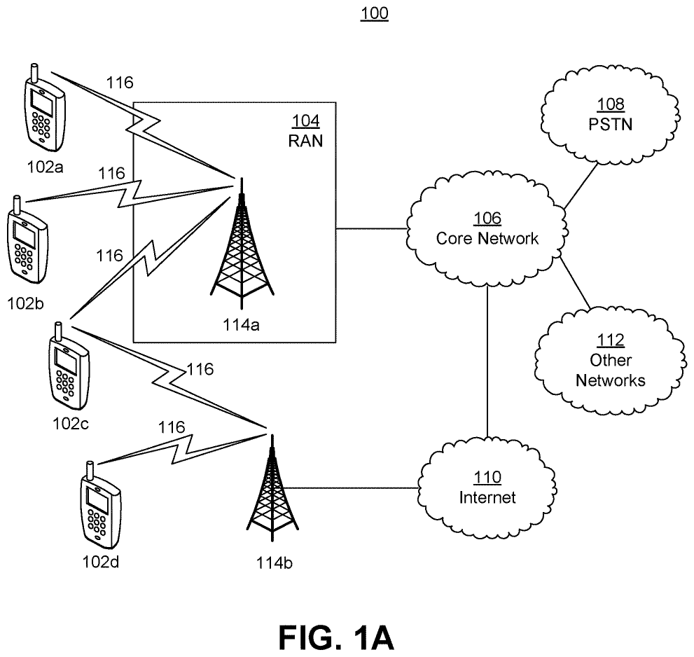

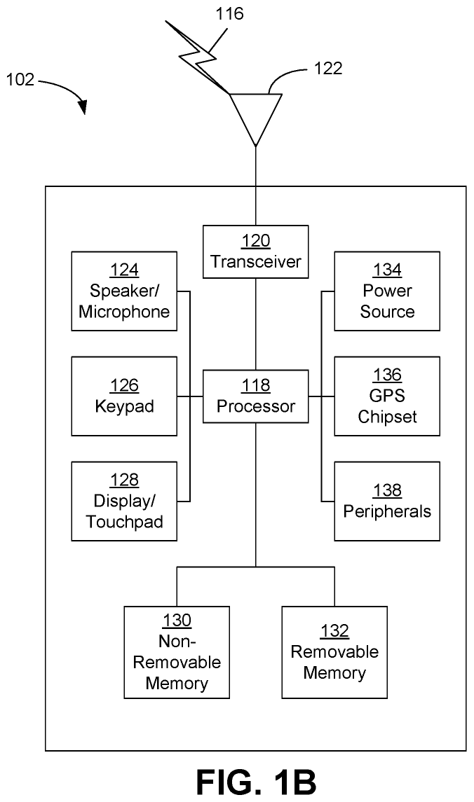

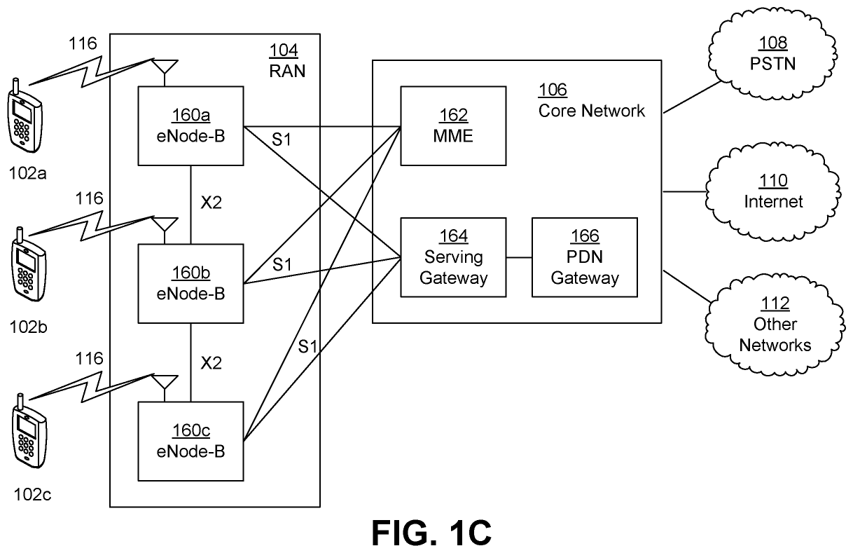

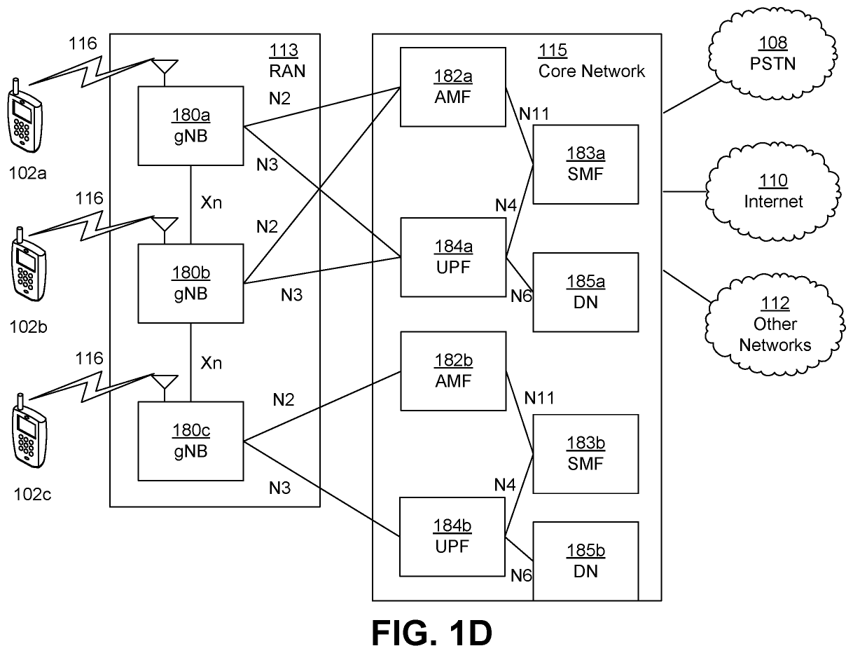

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments are described herein to enhance artificial intelligence (AI)/machine learning (ML) application traffic over device-to-device (D2D) communications are described herein. For example, embodiments may relate to enhancements to (e.g., 5G) proximity-based services (ProSe) communications to define (e.g., new) Helper WTRUs with enhanced Prose Capabilities. A WTRU may indicate the WTRU's capability(ies) to provide volunteering services as a consumer (e.g., a consumer WTRU) and/or producer (e.g., a producer WTRU). A WTRU may indicate in the policy container one or more performance parameters used to request radio access network (RAN) resources. A WTRU may use a Service Request procedure to update the Prose preference with regards to AI/ML application operation requirement/features.

A policy control function (PCF) may generate performance values, for example, to support AI/ML application traffic over the PC5 link. A PCF may use the Access Type preference to indicate whether volunteer-consumer WTRU should use the PC5 link and/or the Uu link when requesting volunteering services (e.g., store and forward and/or process or forward).

An application function (AF) may use AF-based service parameter provisioning to request updates to performance requirements for a specific AI/ML application operation. For example, a WTRU may send a provisioning request that indicates the one or more ProSe capabilities (e.g., including one or more AI/ML application assistance services). The provisioning request may include one or more of: a helper service code, a user information identification, an operation mode, and/or one or more quality of service (QoS) characteristics.

Embodiments are described herein for discovery of AI/ML application helpers. A WTRU that desires to signal its intent to act as a volunteer-producer WTRU may use a specific User information (info) identification (ID) satisfying this criterion. A WTRU acting as a WTRU-to-Network (WTRU-to-NW) relay may (e.g., also) be able to signal that may support, for example, “store and forward” services, “processes and forward” services, or both “store and forward” and “process and forward” services on top of its WTRU's Layer 3 WTRU-to-Network relay services. A WTRU that wants to signal its intent to act as volunteer-producer WTRU may use a specific user information identification (ID) satisfying this criterion. A WTRU may indicate the Helper Service Code, User Info ID, and/or Operation Mode, along with a validity timer associated to Application ID the WTRU provider in the Policy Container. For example, a WTRU may provide the Helper Service Code, User Info ID, and/or Operation Mode, along with a validity timer associated to Application ID the WTRU provider in the Policy Container during the WTRU Configuration Update service operation.

Embodiments are described herein for Prose discovery to support volunteering operations. A WTRU may provide a Prose Application ID and/or operation mode and/or metadata supporting a specific operation mode. A WTRU may provide the mode (e.g., relevant mode) of operation the WTRU is looking for along with metadata associated to the operation mode. A volunteer WTRU may receive the solicitation message. A (e.g., volunteer) WTRU may use discovery filters obtained from the Direct Discovery Name Management Function (DDNMF) to match it against the operation mode and/or metadata features/requirements.

Embodiments are described herein for Prose based connection establishment supporting AI/ML operation traffic. A WTRU performing as volunteering-consumer may select a volunteering-producer and/or may determine applicable Destination Layer-2 ID and/or Helper Service Code to be used. A WTRU performing as volunteering-consumer may send a unicast Direct Communication Request, for example, to signal the WTRU's intent to use “store and forward” and/or “process and forward.”

Embodiments are described herein for one or more procedures to enable 5GS assistance to AI/ML operations in the application layer for communication over PC5 link. A WTRU may engage in application layer communication(s), such as AI/ML federated learning and/or transfer learning. For example, the AI/ML (e.g., 1209) may include one or more algorithms configured for supervised and/or unsupervised learning, as described herein. The WTRU may receive a quality of service (QoS) monitoring request that indicates to monitor one or more application traffic characteristics associated with the application assistance operation mode and/or the one or more ProSe capabilities. The WTRU may provide one or more quality of service (QoS) measurements for QoS monitoring request(s) from the core network (CN). For example, the WTRU may send a QoS monitoring response that indicates one or more QoS monitoring results associated with the one or more application traffic characteristics. The WTRU may provide these measurements to the CN either directly or through the access network (AN). The WTRU may receive (e.g., from the session management function (SMF), policy control function (PCF), and/or the network exposure function (NEF)) an application identification (ID) and/or Group ID and/or Prose identifier. If the WTRU receives the application ID and/or group ID and/or prose identifier from an application function (AF), for example, the packet format information, signaling which PC5 links and/or which PC5 QoS flows may be monitored. The WTRU may use a QoS monitoring policy and/or Prose identifier and/or application ID/Group ID to identify the PC5 QoS flows that may (e.g., may need to) be monitored by the WTRU and/or the eNB, and/or what may (e.g., may need) to be monitored. For example, if the Prose Identifier is associated to a vertical federating learning operation, that is running over a PC5 link using a specific packet format information (PFI), the WTRU may monitor whether the allocated guaranteed flow bit rate (GFBR) and/or one or more other QoS parameters have crossed one or more (e.g., any) thresholds and, if so, report its/their status. For example, the WTRU may report values of one or more (e.g., relevant) parameters which thresholds have been crossed, such as Packet Error Rate (PER), Maximum Data Burst Volume (MDBV), and/or Packet Delay Budget (PDB)

A SMF may use the WTRU-ID to retrieve the session management (SM) context from a unified data manager (UDM) and/or derive the one or more associated packet data unit (PDU) sessions for those WTRUs. The SMF may use the application ID and/or Group ID and/or Prose identifier and/or if provided by the AF, the PFI, to signal the WTRU which PC5 link(s) and/or which PC5 QoS flows may (e.g., may need) to be monitored. The SMF may use the one or more authorized QoS policies provided by the PCF during the Policy Association procedure to construct the QoS Monitoring request.

A NEF and/or PCF may determine to request QoS monitoring from the Access network (e.g., the gNB) and/or from the WTRU, for example, based on one or more operator policies.

The embodiments described herein may include enhancements to support specific traffic characteristics that may be utilized by AI/ML operation(s) running on (e.g., 3GPP) networks and/or other networks. As described herein, AI/ML operation may be split between AI/ML endpoints (e.g., between a WTRU and an AI/ML Applications Server). AI/ML operation may include AI/ML model/data distribution and/or sharing over 3GPP systems (e.g., 5G systems) and/or other networking systems. AI/ML operation may include distributed/federated Learning (FL) over 3GPP systems (e.g., 5G systems) and/or other networking systems.

One or more (e.g., some) telecommunications system(s) (e.g., 3GPP 5G Systems) may call for scenarios that involve AI/ML traffic running between one or more (e.g., multiple) WTRU(s) and an application server, for example, connected through the network (e.g., 3GPP network or other network).

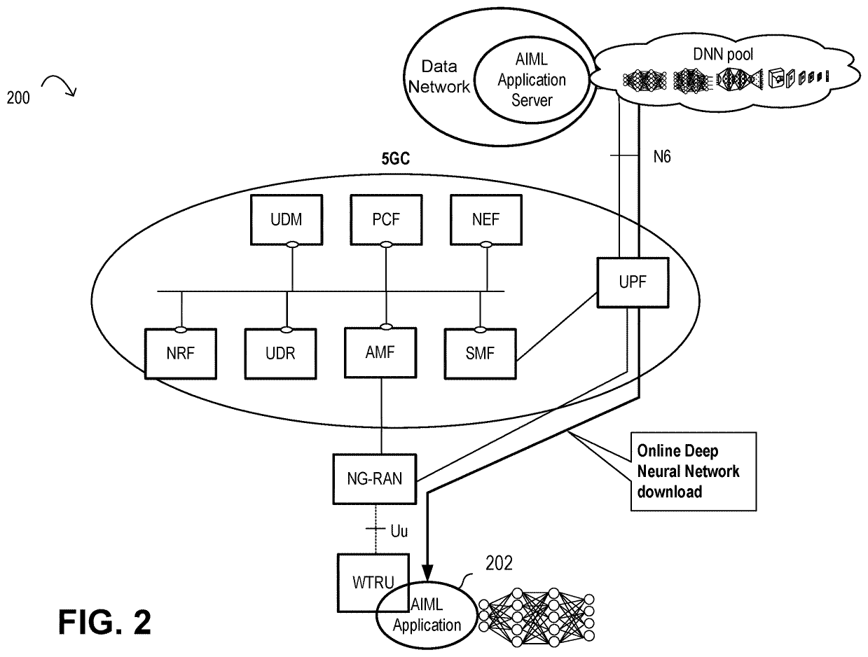

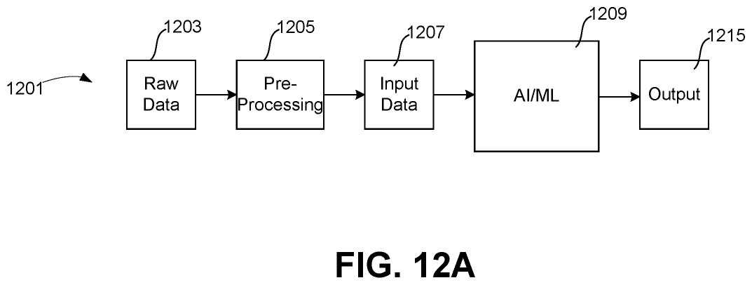

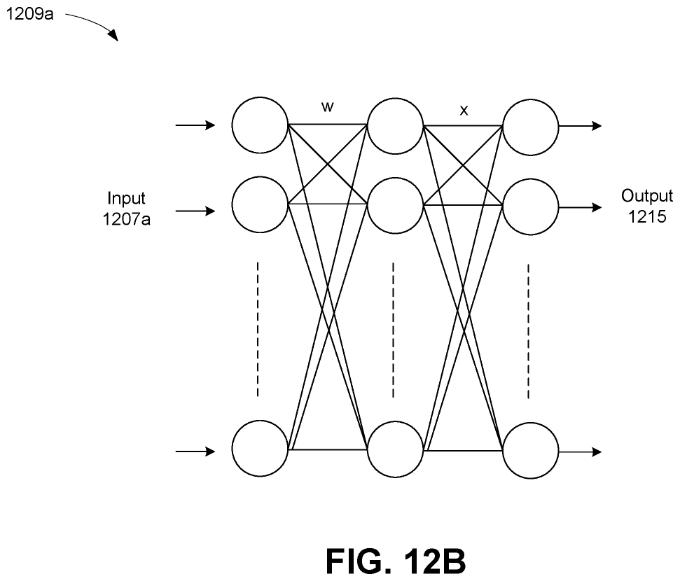

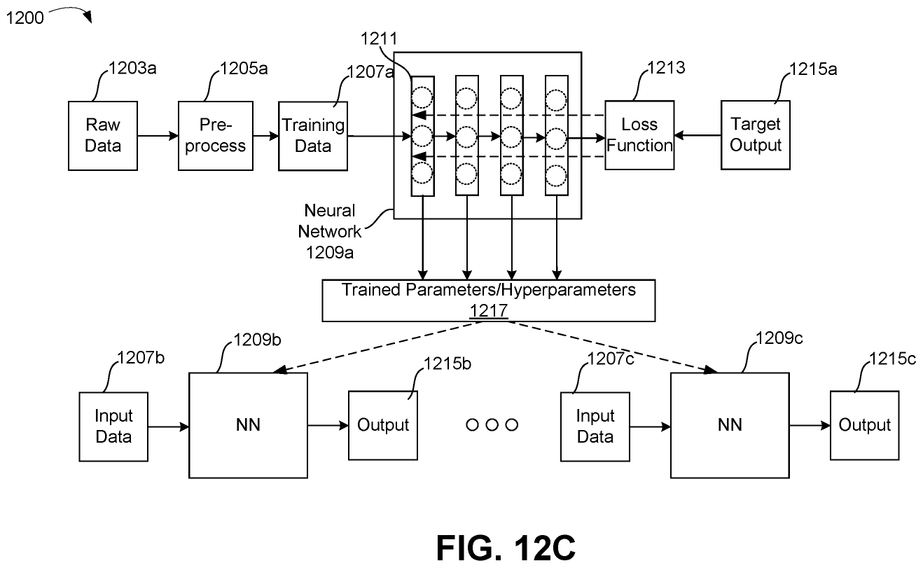

FIG. 2 illustrates an example of an artificial intelligence (AI)/machine learning (ML) model 202 downloading over 5G System (e.g., model distribution) 200. The AI/ML model 202 (e.g., as depicted and/or described in FIGS. 12A to 12C) may be downloaded over a cellular telecommunications system, such as a 5G System (e.g., model distribution). One or more (e.g., some) systems have been introduced that operate in according to such a system configuration, which may assume that AI/ML traffic will be carried over a communication path across the telecommunication system (e.g., 5GS System).

One or more embodiments described herein may be referred to collectively as Assistance to AI/ML Operations in the Application layer. One or more embodiments described herein may include one or more (e.g., new) monitoring events to gauge performance of a connection between an AI/ML Application Function (AI/ML AF) and one or more WTRUs part of an AF Session (e.g., session inactivity and/or traffic volume exchanged between the WTRU and the AI/ML AF). This information may enable (e.g., AI/ML AF) running one or more Federated Learning operations to schedule one or more participant WTRUs to be part of such operation, for example, based on the information provided by the 5GS.

The 5GS may be able to provide assistance to one or more AI/ML AFs, for example, through a feature referred to as member WTRU selection functionality. Member WTRU selection functionality may enable the down selection of member WTRUs that are part of an AI/ML operation but that may (e.g., may need to) comply with specific filtering criteria (e.g., such as certain minimum quality of experience and/or a minimum QoS requirements). The AI/ML AF may (e.g., also) request a time window to transfer one or more large volumes of data (e.g., to transfer ML models) using the Planned Data Transfer with QoS feature, which may enable the transfer of such data at a time where the 5GS is least congested. Additionally or alternatively, the AI/ML AF may request a Multi-member AF session with required QoS for a list of WTRUs identified by WTRU addresses, which may be a way to guarantee one or more 5GS resources to run (e.g., run successfully) an application AI/ML operation. The one or more (e.g., new) features described herein may enable considering an AF session that runs between one or more WTRUs and an AI/ML AF.

Transmission characteristics inherent to device-to-device communications may be helpful in enhancing AI/ML operations (e.g., by providing reduced latency, access to localized data and/or energy savings). In examples, one or more (e.g., some) WTRU(s) may attempt AI/ML model downloading in an area with weak (e.g., poor) radio connection. There may be other WTRU(s) that have a stronger connection and/or stronger overall conditions (e.g., significantly stronger radio conditions, and/or more powerful processing, memory, and/or battery resources). WTRUs with stronger connection and/or stronger overall condition(s) may enjoy privileged conditions that may provide assistance to WTRUs with less favorable conditions, for example, over a sitelink. Such assistance may be delivered in the form of local model downloading, processing offloading, and/or store, process, and/or forward capabilities.

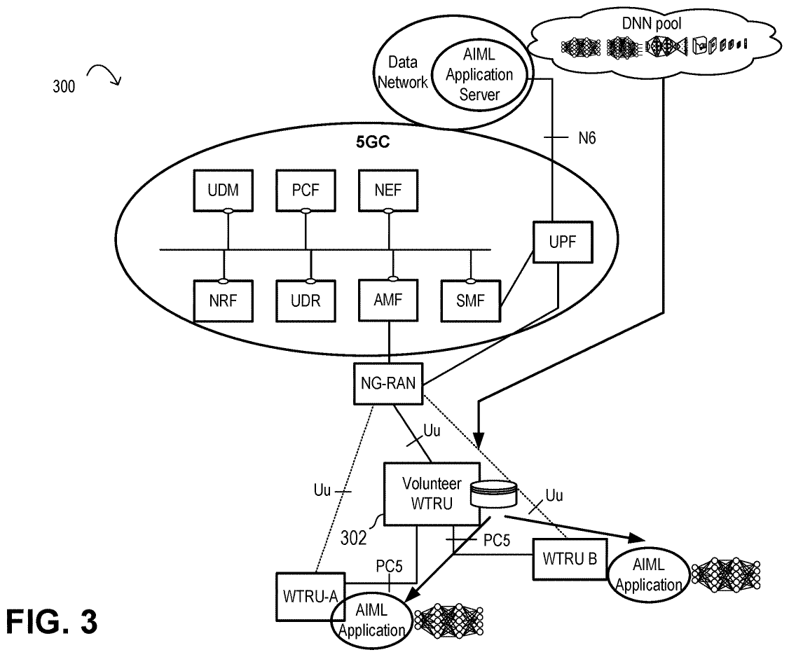

FIG. 3 illustrates an example of AI/ML download 300 from a volunteering WTRU 302. In examples, as FIG. 3 illustrates, a volunteer WTRU 302 that may be contacted by other WTRUs, for example, over a sidelink communication, to download one or more AI/ML models. The one or more AI/ML models (e.g., 1209) may perform as described herein. One or more other WTRUs contacting a volunteering WTRU 302 to download one or more AI/ML models (e.g., 1209, 1209a, and/or as described in FIGS. 12A to 12C) may result in saving radio resources, storage, and/or energy.

Enabling assisted (e.g., 5G-assisted) discovery and/or selection of WTRU(s) providing AI/ML application assistance over device-to-device communications may be described herein. For example, the application assistance operation mode and/or the one or more ProSe capabilities may be associated with one or more AI and/or ML applications. Performance statistics and/or predictions may be used by AI/ML applications to determine whether the available resources are suitable to enable the successful execution of a specific AI/ML application operation. For example, suitability of the available resources may encompass an evaluation to determine whether the current connection is likely to support model downloading. One or more (e.g., some) examples, however, may target connectivity over a PDU Session. In examples, the performance and/or prediction that is performed may be tailored to the type of connection(s), which may exclude device to device communications.

When selecting a member of a group of WTRUs participating in an AI/ML operation, the different roles that these WTRU may play, based on the AI/ML operation, for example, may be different as compared to those cases where the communication is over a PDU session. For example, a group of WTRUs that require AI/ML model download may take advantage of the proximity to other WTRUs and/or when these WTRU(s) are farther away from the gNB. Based on one or more characteristics of such proximity, for example, WTRU members of a group may be in closer proximity to one another but farther away from the gNB; the WTRU members of a group may be discovered and/or selected.

One or more mechanisms may be included to enable AI/ML application to monitor performance statistics and/or predictions of resources supporting AI/ML sessions, for example, over device-to-device communications. Mechanisms may be included to enable AI/ML application to monitor performance statistics and/or prediction of resources supporting AI/ML communications. Mechanisms may be included to help the AI/ML application discover and/or select members of a group and/or possibly the roles these members should play within the group.

WTRU-to-Network-Relays may be enabled to provide store/processing-and-forward capabilities, as described herein.

A volunteer WTRU which is well connected to the base station may help receive and/or store AI/ML models (e.g., first receive and/or store AI/ML models). The other WTRUs may (e.g., then) download one or more AI/ML models from the volunteer WTRU through direct device connection. A mechanism may be implemented that enables an intermediate node, such as WTRU-to-Network relay, to serve as a helper and/or as a volunteer in a way that other WTRU(s) can benefit from its temporary privileged capability. In one or more (e.g., some) examples, the WTRU-to-Network Relays may not store and forward information, and/or process and forward information. Rather, WTRU-to-Network Relays may forward the content of a message received from a remote node towards WTRU(s) connected to the relay.

Described herein are embodiments for enabling AI/ML application to determine whether the WTRU can provide WTRU-to-Network Relay capabilities while also being able to store and forward and/or process and forward AI/ML application traffic and/or any other application traffic.

One or more examples are described herein for enabling WTRUs to discover whether the WTRU-to-Network Relay can store and forward information, process and store information, and/or both.

One or more examples are described herein for enabling the WTRU to negotiate additional services (e.g., “stored and forward”, “process and forward”, and/or both) that can be provided at the discovered WTRU-to-Network Relay WTRUs.

Described herein are embodiments for enabling 5GS WTRU-to-Network Relay(s) to be discovered based on its computation capabilities. Computation-integrated relay may be included in other (e.g., future) wireless as a type of relay service, where a relay WTRU may aggregate data received from one or more (e.g., multiple) WTRU(s) (e.g., and/or with the relay WTRU's own data), generate an aggregated data, and/or forward the aggregated data to the one or more other entities (e.g., a network function, an application function, and/or another WTRU). For example, the relay WTRU may perform model aggregation for a federated learning task.

One or more ProSe service(s) in 5GS may be communication-oriented and/or may not support this type of WTRU-to-NW relay service(s). For example, if the WTRU-to-NW relay cannot perform the (e.g., required) computation, the WTRU-to-NW relay may not be selected as a relay node even if it can provide a communication-oriented relay.

Enhancements to 5G ProSe Capability may be described herein. Although the enhancements described herein may focus on WTRU-to-NW relay services, they can (e.g., directly) be applied to WTRU-to-WTRU relay services as well (e.g., by replacing WTRU-to-NW with WTRU-to-WTRU in the one or more enhancements described herein).

One or more embodiments are described herein for implementing 5G ProSe Capability. Although the one or more embodiments described herein may focus on WTRU-to-NW relay service(s), for example, the one or more embodiments may (e.g., directly) be applied to WTRU-to-WTRU relay service(s) (e.g., may replace WTRU-to-NW with WTRU-to-WTRU in the one or more embodiments described herein).

The embodiments described herein may enable AI/ML application traffic carried over device-to-device communications to take advantage of one or more unique characteristics that one or more are WTRUs performing as remote WTRUs and/or WTRU-to-Network relay WTRUs may provide to other WTRUs. A remote WTRU may be a WTRU at the other side of the relay WTRU-to-network relay. For example, while executing a processing intensive, delay sensitive AI/ML operation, a remote WTRU may be able to discover, select, and/or negotiate specific services from peer WTRUs and/or WTRU-to-Network relay WTRUs. Peer WTRUs may be defined as two or more WTRUs connected to one another, for example, via a direct PC5 connection. Prose Services may be one or more (e.g., any) services (e.g., gaming, extended reality services, and/or the like) and/or they may be AI/ML operations that may include: local AI/ML model download; processing of offline inference; and/or relaying interim training results and/or relaying models downloaded from the edge/cloud servers. The embodiments herein may include mechanisms and/or procedures to allow WTRUs to proactively volunteer as helpers, for example, to support AI/ML application traffic and/or one or more (e.g., any) other traffic, while also performing/acting as peer WTRUs and/or WTRU-to-Network relay WTRUs and/or offer preprocessing and/or aggregation of the traffic coming from two or more WTRUs, for example, before this traffic may be further forwarded to one or more other WTRUs and/or forwarded to the network.

For example, a WTRU-to-Network relay may offer downloading and/or storage of one or more ML models that can be (e.g., further) downloaded by one or more other WTRUs connected to the WTRU-to-Network Relay. The WTRU-to-Network relay may offer ML model aggregation, which may enable one or more WTRUs connected to the WTRU-to-Network relay to send the intermediate model which may be further processed (e.g., aggregated) before sending the intermediate ML model to the AI/ML AF. One or more (e.g., new) mechanisms to enable AFs to request QoS monitoring for WTRU engaged in communications over PC5 links are described herein.

Embodiments are described herein that enable enhancements to Prose Services (e.g., 5G Prose Services) to support AI/ML Traffic. During Initial Registration Procedure, the WTRU may provide, as part of the capability (e.g., 5GMM capability) an indication of whether the WTRU is capable to process and/or forward packets from peer/remote WTRUs, store and forward packets from remote/peer WTRUs, and/or both. Store and Forward functionality may be useful for one or more AI/ML operations that are related to Model distribution and/or sharing where the WTRU-to-Network relay WTRU can store models that are then distributed (e.g., immediately) and/or at a later stage toward remote WTRUs that request these models during the ProSe Direct Communication stage. Processing and Forward functionality may be useful for AI/ML operation that relate to Federated Learning operation where trained models from remote WTRUs can be further processed at the WTRU-to-Network relay WTRU, before being forward to the AI/ML application server.

The information described herein may be added to the Prose Capability (e.g., 5G Prose Capability). For example, the Prose Capability (e.g., 5G Prose Capability) may indicate whether the WTRU supports Direct Discovery (e.g., 5G Prose Direct Discovery). The Prose Capability (e.g., 5G Prose Capability) may indicate whether the WTRU supports Prose Direct Communication (e.g., 5G Prose Direct Communication). The Prose Capability (e.g., 5G Prose Capability) may indicate whether the WTRU supports Prose Direct Communication (e.g., 5G Prose Direct Communication), supporting store and forward. The Prose Capability (e.g., 5G Prose Capability) may indicate whether the WTRU supports Prose Direct Communication (e.g., 5G Prose Direct Communication), supporting process and forward. The Prose Capability (e.g., 5G Prose Capability) may indicate whether the WTRU supports Prose Direct Communication (e.g., 5G Prose Direct Communication), supporting both store and forward and process and forward. The Prose Capability (e.g., 5G Prose Capability) may indicate whether the WTRU supports Prose Layer-2 WTRU-to-Network Relay (e.g., 5G Prose Layer-2 WTRU-to-Network Relay). The Prose Capability (e.g., 5G Prose Capability) may indicate whether the WTRU supports Prose Layer-3 WTRU-to-Network Relay (5G Prose Layer-3 WTRU-to-Network Relay). The Prose Capability (e.g., 5G Prose Capability) may indicate whether the WTRU supports Prose Layer-3 WTRU-to-Network Relay (e.g., 5G Prose Layer-3 WTRU-to-Network Relay), supporting store and forward. The Prose Capability (e.g., 5G Prose Capability) may indicate whether the WTRU supports Prose Layer-3 WTRU-to-Network Relay (e.g., 5G Prose Layer-3 WTRU-to-Network Relay), supporting process and forward. The Prose Capability (e.g., 5G Prose Capability) may indicate whether the WTRU supports Prose Layer-3 WTRU-to-Network Relay (e.g., 5G Prose Layer-3 WTRU-to-Network Relay) supporting both store and forward and process and forward. The Prose Capability (e.g., 5G Prose Capability) may indicate whether the WTRU supports Prose Layer-2 Remote-WTRU (e.g., 5G Prose Layer-2 Remote-WTRU). The Prose Capability (e.g., 5G Prose Capability) may indicate whether the WTRU supports Prose Layer-3 Remote-WTRU (e.g., 5G Prose Layer-3 Remote-WTRU).

The WTRU may indicate if the capability is used as volunteer-provider and/or as a volunteer consumer. For example, the WTRU may indicate if the capability is used as a volunteer-provider and/or as a volunteer consider within the Policy Container Sent to the AMF in the Registration message.

A WTRU may require assistance from one or more other WTRUs to, for example, execute ML model downloading on its behalf, and/or to execute ML model aggregation before the intermediate model is sent from a helper WTRU an AF. A WTRU may provide assistance information to one or more other WTRUs, for example, to store one or more ML models and/or make the one or more ML models available to one or more other WTRUs and/or to perform one or more model aggregation operations before the intermediate model ML is sent to the central AF. When a WTRU declares its intent to assist one or more other WTRUs, for example, to store and forward and/or to process and forward data from WTRUs requesting assistance, this WTRU may be referred to as a Volunteering-Provider. A WTRU that seeks assistance from a Volunteering-Provider WTRU may be referred to as a Volunteering-consumer WTRU.

Depending on the Prose capability, for example, the WTRU may provide in the policy container the parameters (e.g., specific parameters) to request relevant resources from the next generation (NG)-RAN. The AMF may authorize the one or more capabilities, for example, via UDM (e.g., authorization obtained from the subscriber record and/or subscription data).

The AMF may store the capabilities, and/or may use the capabilities to discover (e.g., via a network repository function (NRF) a PCF that can handle them. Prose NR WTRU-PC5-aggregate maximum bit rate (AMBR) may also be provided to the AMF, for example, as in one or more (e.g., current) Prose procedures. If the WTRU is authorized to use the capabilities, for example, the AMF may include the capabilities in the NG Application Protocol (NGAP) message sent to the RAN.

The RAN may (e.g., continue) to operate with similar functionality. The AMF may choose different NR WTRU-PC5-AMBR values, for example, depending on whether the WTRU has signaled the WTRU's intent to be a consumer of the volunteering service and/or the volunteer producer. The AMF may get PC5 QoS parameters that the PCF generates during the policy association establishment and/or modification procedure.

The PCF may use the (e.g., new) parameter values that the WTRU provided in the Policy Container to generate the values associated to the application AI/ML operation traffic that may include support over the PC5 link. The PCF may use the Access Type preference to indicate whether a WTRU should use a volunteer-provider WTRU as the preferred access. The PCF may use the Access Type preference to indicate whether a WTRU should use a volunteer-provider WTRU as the preferred access, and/or whether this role should be played as a WTRU-to-Network Relay and/or as peer WTRU over a PC5 link.

The parameters described herein may vary depending on whether the WTRU is operating as a volunteer-provider and/or as a volunteer-consumer. The AMF may relay the parameters to the NG-RAN and/or the WTRU.

WTRUs may use a Service Request procedure to update Prose preferences with regards to AI/ML application operation requirements. The AIML Application Function may use Service Specific information provisioning functionality (e.g., AF-based service parameter provisioning) to request updates to AI/ML Application parameter values. The AI/ML Application Function may use Service Specific information provisioning functionality to support AI/ML application characteristics for a specific AI/ML Application Operation. Depending on the application AI/ML operation type (e.g., FL and/or Model Delivery), the AF and/or Application server may update the one or more requirements (e.g., may be referred to as characteristics herein) for one or more different application AI/ML operations. For example, a Vertical Federated Learning operation may have different delay requirements than a Model Distribution/Model Delivery operation. The AI/ML Application Server (AS) may provide a path preference associated to specific QoS characteristics for certain application(s). For example, AI/ML application characteristics that the AI/ML Application Server (AS) may update may include one or more of: the expected transmission delay features/requirements; DL/uplink (UL) bit rate for traffic going over PC5; failure to comply to QoS parameter values (e.g., guaranteed flow bit rate (GFBR)/maximum flow bit rate (MFBR)); and/or specific PQI value(s). The AI/ML AS may provide a path preference associated to specific QoS characteristics for certain application, for example, to force traffic towards a volunteer WTRU that supports these characteristics. Network Analytics may be used to collect WTRU information to support Prose based communication (e.g., by extending the DCAF functionality). For example, analytics may be collected depending on whether a PC5 link is being used to provide store and forward and/or process and forward capabilities.

One or more embodiment(s) are described herein for (e.g., 5G) ProSe Capability (e.g., an enhanced 5G ProSe Capability) to support Computation-Integrated ProSe. ProSe Capability (e.g., 5G ProSe Capability) may indicate whether a WTRU (e.g., a relay WTRU and/or a remote WTRU) supports one or more following computation-integrated ProSe capability(ies): 5G ProSe computation-integrated relay that the relay WTRU can support certain computation operations over one or more packets received from the one or more remote WTRU(s); and/or 5G ProSe computation-integrated relay that a remote WTRU may be configured (e.g., may be willing) to have its packets computed with one or more certain computation operations by a relay WTRU (e.g., WTRU-to-NW relay).

Computation operations may be, but not limited to, one or more of the following.

A first computation operation example may include adding new context. A remote WTRU-A may send one or more packets to the relay WTRU. Each packet may include one or more (e.g., some) sensing information collected by the remote WTRU-A. But additional context information may (e.g., may need) to be added to each packet. Additional context information may include multimodal data such as, but not limited to, the location of the relay WTRU, and/or sensing information from one or more other remote WTRUs. For this example, the parameter 5G ProSe Capability may (e.g., additionally) indicate Capability of Adding New Context Information.

A second computation operation example may include continued AI model training. One or more packets from a remote WTRU may include a partial AI model (e.g., the output of the first few layers of a deep neural network model). The remote WTRU may send the partial AI model in one or more (e.g., multiple) packets to the relay WTRU. The relay WTRU may receive the one or more packets. The relay WTRU may continue to train the AI model, for example, using the partial AI model. For this example, the parameter 5G ProSe Capability may (e.g., additionally) indicate Capability of Performed Continued AI Model Training as a Relay WTRU.

A third computation operation example may include AI model fine-tuning. One or more packets from a remote WTRU may include further improving the accuracy of an AI model. The remote WTRU may send the AI model to the relay WTRU. For example, the remote WTRU may send the AI model in one or more (e.g., multiple) packets to the relay WTRU. The relay WTRU may receive the one or more packets. The relay WTRU may retrain, fine-tune, and/or customize the AI model, for example, using additional training data generated by the relay WTRU and/or received from one or more other remote WTRUs. The relay WTRU may retrain, fine-tune, and/or customize the AI model to produce another (e.g., new) AI model with a higher accuracy. For this example, the parameter 5G ProSe Capability may (e.g., additionally) indicate Capability of performing AI model fine-tuning as a relay WTRU.

A fourth computation operation example may include AI model pruning. One or more packets from a remote WTRU may include an AI model of a large size. The remote WTRU may send the AI model in one or more (e.g., multiple) packets, since the size of the AI model may be large, to the relay WTRU. The relay WTRU may receive the one or more packets. The relay WTRU may perform a computation operation over the received AI model to remove one or more (e.g., some) weight parameters of the AI model to generate another (e.g., new) AI model with less parameters (e.g., reduced model size). For this example, the parameter 5G ProSe Capability may (e.g., additionally) indicate Capability of performing AI model pruning as a relay WTRU.

A fifth computation operation example may include AI model quantization. One or more packets from a remote WTRU may include an AI model of a large size. The remote WTRU may send the AI model in one or more (e.g., multiple) packets, since the size of the AI model may be large, to the relay WTRU. The relay WTRU may receive the one or more packets. The relay WTRU may perform a computation operation over the received AI model to quantize each weight parameter(s) of the AI model to reduce the model size. For this example, the 5G ProSe Capability may (e.g., additionally) indicate Capability of performing AI model quantization as a relay WTRU.

The relay WTRU may be a WTRU-to-NW relay WTRU and/or a WTRU-to-WTRU relay WTRU. The computation example(s) that the relay WTRU may support include one or more of the following. The relay WTRU may compress the content included in a single packet from a remote WTRU. The relay WTRU may combine, aggregate, and/or compress the contents included in one or more (e.g., multiple) packet(s) from the (e.g., same) remote WTRU. The relay WTRU may combine, aggregate, and/or compress the contents included in one or more (e.g., multiple) packet(s), for example, where the one or more packets (e.g., each) are from a different remote WTRU. The relay WTRU may combine, aggregate, and/or compress the contents included in one or more (e.g., multiple) packet(s) (e.g., each from a different remote WTRU) together with an additional content the relay WTRU may generate and/or host locally. The relay WTRU may split the content included in a single packet from a remote WTRU and/or generate one or more (e.g., multiple) packet(s) (e.g., additional packet(s). The relay WTRU may append an additional content to a single packet from a remote WTRU. The relay WTRU may analyze the content included in one or more (e.g. multiple) packet(s) from the same remote WTRU (e.g., using an AI algorithm/tool/model) to extract (e.g., meaningful) information from the one or more (e.g., multiple) packets. The relay WTRU may analyze the content included in the one or more (e.g., multiple) packet(s) from different remote WTRU(s) (e.g., using an AI algorithm/tool/model) to extract (e.g., meaningful) information from the one or more (e.g., multiple) packet(s).

Such computation may be performed (e.g., solely) over one or more packet(s) from a single remote WTRU. Additionally or alternatively, such computation may be performed over one or more packet(s) from one or more (e.g., multiple) remote WTRUs. Additionally or alternatively, such computation may be performed over one or more packet(s) from one or more remote WTRU(s) and the relay WTRU. The additional packet(s) the WTRU generates when executing computation over one or more packets received from the remote WTRU(s), may modify, enhance, and/or replace the semantics of the original content from the packets received from the remote WTRU(s).

Additionally or alternatively, the 5G ProSe Capability may indicate whether the relay WTRU and/or a remote WTRU support one or more following computation-integrated ProSe capability(ies): 5G ProSe computation-integrated relay where the relay WTRU can perform one or more computations over one or more packet(s) from the same remote WTRU; 5G ProSe computation-integrated relay that a remote WTRU may be configured to (e.g., may be willing) to have its one or more packets to be computed separately by a WTRU-to-NW relay; 5G ProSe computation-integrated relay where the relay WTRU can perform computation over one or more packets from one or more different remote WTRUs; 5G ProSe computation-integrated relay that a remote WTRU may be configured to (e.g., may be willing to) have its one or more packet(s) to be computed with one or more packet(s) from one or more other remote WTRU(s) by a WTRU-to-NW relay; 5G ProSe computation-integrated relay where the relay WTRU can perform computation over one or more packet(s) from one or more remote WTRU(s) together with the packet that the relay WTRU generates (e.g., locally); and/or 5G ProSe computation-integrated relay that a remote WTRU may be configured to (e.g., may be willing to) have its one or more packet(s) to be computed with one or more packet(s) from one or more (e.g., any) other WTRU(s) by WTRU-to-NW relay.

A computation instruction may specify the computation that the relay WTRU may perform. One or more (e.g., each) computation scenario(s), as described herein, may include one or more different computation instruction(s). The relay WTRU may perform computation that is application independent and/or application-dependent. For example, when the relay WTRU performs (e.g., simple) computation (e.g., the combination and/or aggregation of one or more packets from one or more/multiple remote WTRU(s)), the relay WTRU may not understand the content included in those one or more packet(s). Thus, for example, such (e.g., simple) computation may be application-independent. For example, computation instruction may include an indication to combine every three packets from a remote WTRU into another packet. For one or more other computations (e.g., to analyze the content included in one or more packet(s) to extract information), the relay WTRU may (e.g., may need) to understand the content included in the one or more packet(s), which may be application-dependent. Such computation may include the relay WTRU getting (e.g., receiving) one or more (e.g., some) input(s) (e.g., the AI tool/model used to analyze the content included on the one or more packets) from one or more application(s) residing in the one or more remote WTRU(s). For application-dependent computation, one or more computation instructions may be dependent of the application on one or more remote WTRU(s). Those applications may specify and/or configure one or more computation instructions in the one or more packets (e.g., in band) and/or (e.g., directly) to the relay WTRU (e.g., out of band).

Although a computation instruction may be application-dependent, for example, a computation instruction may include one or more of the following (e.g., common) parameters: Computation Scope; Computation Level; and/or one or more Target WTRU(s). Computation Scope may include a description of the target WTRU(s) that the computation may be performed by a relay WTRU to and/or for a relay WTRU. The value of this parameter may include indications of: one remote WTRU, across one or more (e.g., multiple) remote WTRU(s), across one remote WTRU and/or the relay WTRU, and/or across one or more (e.g., multiple) remote WTRU(s) and/or the relay WTRU. Computation level may include packet level (e.g., to combine one or more/multiple packet(s)). Computation level may include content level (e.g., to extract information from the content included in one or more/multiple packet(s)), etc. Target WTRU(s) may indicate a list of one or more remote WTRU(s), which corresponds to the Computation Scope.

A WTRU may send indications of computation-integrated ProSe capabilities to an AMF. The WTRU (e.g., a relay WTRU and/or a remote WTRU) may send the one or more indication(s) of the computation-integrated ProSe capability(ies), as described herein, to the WTRU's Access and Mobility function (AMF) by embedding the parameter 5G ProSe Capability in a registration request message, in a service request message, and/or in a registration update message. The AMF may determine if the WTRU is authorized to use computation-integrated 5G ProSe relay service(s). For example, the AMF may determine if the WTRU is authorized to use computation-integrated 5G ProSe relay service(s) based on its 5G ProSe Capability and/or its subscription data that the AMF can retrieve from Unified Data Management (UDM). The AMF may store the authorized computation-integrated 5G ProSe service(s). Additionally or alternatively, the AMF may send the authorized computation-integrated 5G ProSe service(s) to the Policy Control Function (PCF). The PCF may determine one or more PC5 QoS parameter(s) according to the authorized computation-integrated 5G ProSe Capability and/or may send one or more PC5 QoS parameter(s) to the AMF, which may be stored at the AMF as part of the WTRU context.

After the AMF stores 5G ProSe Capability with the computation-integrated ProSe capability indication, for example, one or more other Network Functions (NFs) (e.g., 5G Direct Discovery Name Management Function (DDNMF) may retrieve 5G ProSe Capability of a given WTRU and/or subscribe to one or more (e.g., any) change(s) to a given WTRU's 5G ProSe Capability from the AMF, e.g., to retrieve and/or subscribe to a given WTRU's computation-integrated ProSe capability(ies).

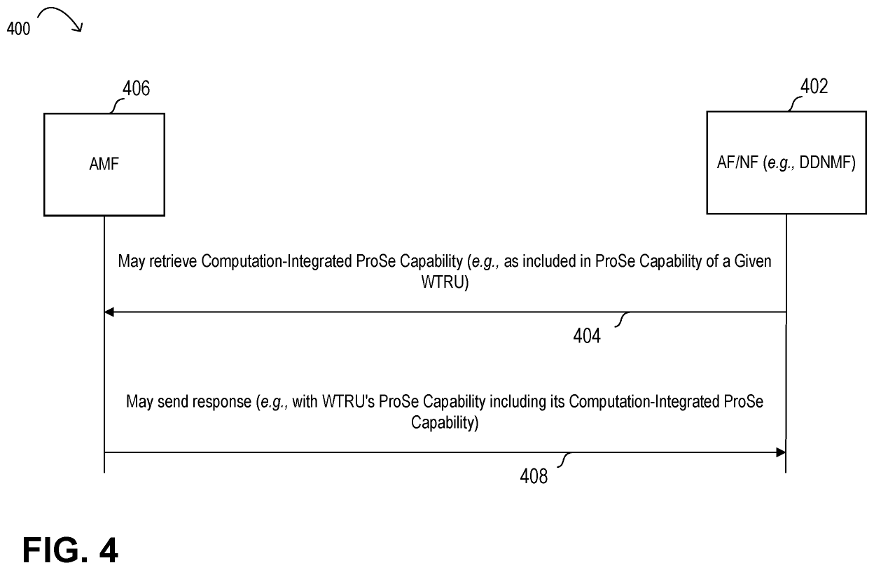

FIG. 4 illustrates a flow diagram that depicts an example of a procedure for a NF and/or an application function (AF) 402 to retrieve the computation-integrated ProSe capability of a given WTRU (e.g., a relay WTRU and/or a remote WTRU). As an example, a NF 402 (and/or an AF) may (e.g., may need) to select a relay WTRU for one or more (e.g., multiple) remote WTRUs. For this purpose, for example, the NF 402 may (e.g., first) get the one or more computation requirements of the remote WTRUs; the NF 402 may (e.g., also) know one or more (e.g., some) potential relay WTRUs which are in the proximity of the one or more remote WTRUs. The NF 402 may (e.g., then) use the one or more procedures described herein (e.g., procedure(s) outlined in FIG. 4) to retrieve computation-integrated ProSe capability of one or more (e.g., each) of those potential relay WTRUs. The NF 402 may (e.g., finally) select a potential relay WTRU as the relay WTRU for the remote WTRUs, for example, if its computation-integrated ProSe capability(ies) meet(s) the computation requirement(s) of the remote WTRUs.

At 404, the NF/AF 402 (e.g., AF, 5G DDNMF) may send a request to the AMF 406. The request may indicate that the NF/AF 402 wants to retrieve the computation-integrated ProSe capability of a given WTRU. The request may include the identifier of the WTRU. The request 404 may include a specific Computation Level and/or Computation Scope to indicate that the NF/AF 402 wants to retrieve the WTRU's capability related to this specific Computation Level and/or Computation Scope.

The AMF 406 may look up its WTRU context database against the WTRU′ identifier (e.g., and/or Computation Level and/or Computation Scope if included herein) and/or may find the WTRU's computation-integrated ProSe capability. At 408, the AMF 406 may send a response to the NF/AF 402 including the found computation-integrated ProSe capability of the WTRU. If the WTRU does not support computation-integrated ProSe, for example, this response 408 may indicate the WTRU does not support computation-integrated ProSe and/or this response 408 (e.g., simply) may include an empty message (e.g., the response may only include a header without any content body).

An Application Function (AF) (e.g., ProSe Application Server) may retrieve the WTRU's computation-integrated ProSe capability from the AMF directly (e.g., if the AF is trusted by 5GS) and/or indirectly via a Network Exposure Function (NEF), using one or more of the procedures described herein.

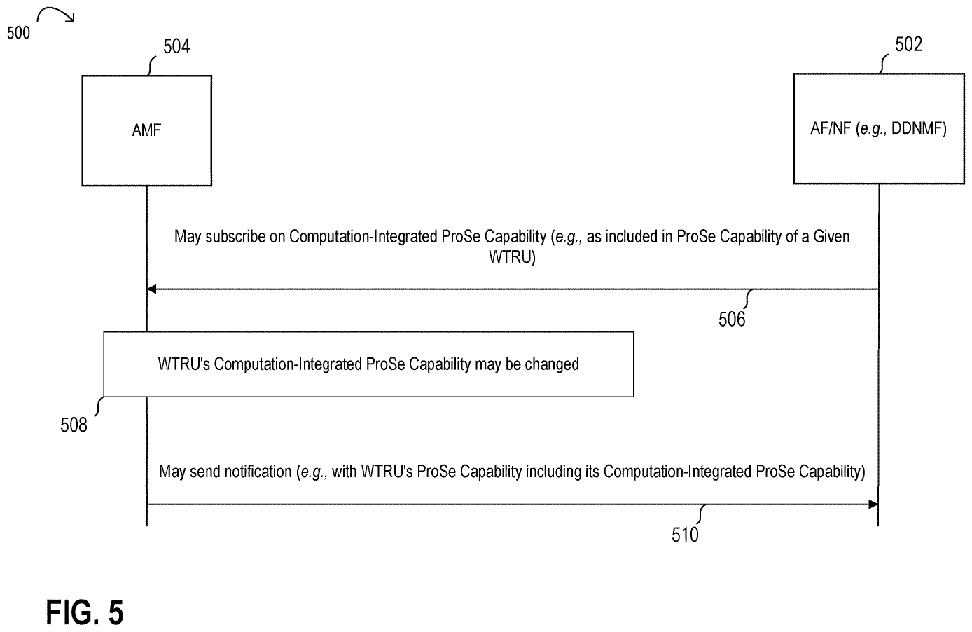

FIG. 5 illustrates a flow diagram that depicts an example of a procedure 500 for a NF and/or an application function (AF) 502 to subscribe on the one or more change(s) to the computation-integrated ProSe capability of a given WTRU (e.g., a relay WTRU and/or a remote WTRU). As an example, a NF 502 (and/or an AF) may have selected and/or approved a relay WTRU with computation-integrated ProSe capability for one or more (e.g., some) remote WTRUs, but may ensure (e.g., may need to guarantee) that the relay WTRU can support (e.g., always support) computation-integrated ProSe capability as required by the remote WTRU. For this purpose, for example, the NF 502 may (e.g., first) use one or more procedures as described herein (e.g., one or more procedures of FIG. 5) to subscribe on one or more (e.g., any) changes of computation-integrated ProSe capability of the relay WTRU. If the relay WTRU decides not to support computation-integrated ProSe capability at a later time, e.g., the relay WTRU may (e.g., need to) reduce the energy consumption from computation. For example, the WTRU may send another (e.g., new) (e.g., 5G) ProSe Capability indication to its serving AMF 504 (e.g., via a registration update), which may indicate that the relay WTRU does not support computation-integrated ProSe capability. The serving AMF 504 may send a notification including the relay WTRU's other (e.g., new) (e.g., 5G) ProSe Capability to the NF 502. The NF 502 (e.g., AF, DDNMF) may decide to choose another relay WTRU and/or may inform one or more remote WTRUs that the relay WTRU no longer holds computation-integrated ProSe capability.

At 506, the NF 502 (e.g., AF, DDNMF) may send a request to the AMF 504. The request 506 may indicate that the NF 502 wants to subscribe on the one or more change(s) to the computation-integrated ProSe capability(ies) of a given WTRU. The request 506 may include the identifier of the WTRU. An Application Function (AF) (e.g., ProSe Application Server) may subscribe to the one or more change(s) to the WTRU's computation-integrated ProSe capability from the AMF directly (e.g., if the AF is trusted by 5GS) and/or indirectly via a Network Exposure Function (NEF), using one or more of the procedures described herein.

At 508, the WTRU's computation-integrated ProSe capability may include a change (e.g., WTRU may become to not support computation-integrated ProSe capability, the relay WTRU may need to reduce the energy consumption from computation, etc.). For example, the relay WTRU may send a (e.g., new) ProSe capability indication (e.g., a 5G ProSe capability indication) to its serving AMF (e.g., via a registration update). The ProSe capability indication may indicate that the relay WTRU will not support computation-integrated ProSe capabilities.

At 510, the AMF 504 may send a notification to the NF 502 including the changed computation-integrated ProSe capability of the WTRU.

Systems, methods, and apparatuses are described herein for enhanced 5G ProSe Authorized Information to support Computation-Integrated ProSe. Authorization may include a WTRU that is authorized to provide computation-integrated ProSe capability.

After a WTRU (e.g., a relay WTRU and/or a remote WTRU) sends 5G ProSe Capability to its AMF, for example, the AMF may determine if the WTRU is authorized to use computation-integrated 5G ProSe relay service(s) based on its 5G ProSe Capability(ies) and/or its subscription data that the AMF can retrieve from the UDM. The AMF may store the authorized computation-integrated 5G ProSe service(s) and/or may send it to the PCF. The PCF may determine one or more PC5 QoS parameter(s) according to the authorized computation-integrated 5G ProSe Capability and/or may send one or more PC5 QoS parameter(s) to the AMF, which may be stored at the AMF as part of the WTRU context.

If the WTRU is authorized to provide and/or use computation-integrated 5G ProSe relay service(s), for example, its AMF may send 5G ProSe Authorized Information to NG-RAN, which may include one or more of the following authorized computation-integrated ProSe capabilities: whether the WTRU is authorized to provide 5G ProSe computation-integrated relay service(s) as a WTRU-to-NW relay to perform computation over one or more packet(s) received from one or more remote WTRU(s); whether the WTRU is authorized to use 5G ProSe computation-integrated relay service(s) to have its one or more packet(s) to be sent to and/or computed by a relay WTRU (e.g., WTRU-to-NW relay); the list of WTRU-to-NW relay(s) that the WTRU may leverage 5G ProSe computation-integrated relay service(s) (e.g., and/or 5G ProSe service(s) from; and/or the list of one or more remote WTRU(s) that the WTRU may provide 5G ProSe computation-integrated relay service(s) (e.g., and/or 5G ProSe service(s)) to.

Additionally or alternatively, the 5G ProSe Authorized Information may include one or more of the following authorized computation-integrated ProSe capabilities: whether the WTRU is authorized to use 5G ProSe computation-integrated relay service(s) to have its one or more packet(s) to be computed (e.g., separately) by a WTRU-to-NW relay; whether the WTRU is authorized to provide 5G ProSe computation-integrated relay service(s) as a WTRU-to-NW relay where the WTRU may perform computation over one or more packet(s) from one or more different remote WTRU(s); whether the WTRU is authorized to use 5G ProSe computation-integrated relay service(s) to have its one or more packet(s) to be computed with one or more packet(s) from one or more remote WTRU(s) by a WTRU-to-NW relay; whether the WTRU is authorized to provide 5G ProSe computation-integrated relay service(s) as a WTRU-to-NW relay where the WTRU may perform computation over one or more packet(s) from one or more remote WTRU(s) together with the packet that the WTRU generates (e.g., locally); and/or whether the WTRU is authorized to use 5G ProSe computation-integrated relay service(s) to have its one or more packet(s) to be computed with one or more packets from one or more (e.g., any other) WTRU(s) by a WTRU-to-NW relay.

Additionally or alternatively, the 5G ProSe Authorized Information may include one or more of the following authorized computation-integrated ProSe capability(ies): Whether the WTRU is authorized to provide 5G ProSe computation-integrated relay service(s) as a WTRU-to-NW relay where the WTRU may perform computation according to one or more in-band computation instruction(s) embedded in the one or more packet(s) from the one or more remote WTRU(s); Whether the WTRU is authorized to use 5G ProSe computation-integrated relay service(s) where the WTRU may be willing to embed one or more in-band computation instructions in its one or more packet(s) and/or may be willing to have its one or more packets to be computed by a WTRU-to-NW relay; Whether the WTRU is authorized to provide 5G ProSe computation-integrated relay service(s) as a WTRU-to-NW relay where the WTRU may perform computation according to one or more out-of-band computation instruction(s) (e.g., packet aggregation instructions) being configured and/or provisioned to the WTRU; and/or whether the WTRU is authorized to use 5G ProSe computation-integrated relay service(s) where the WTRU may be willing to have its one or more packet(s) to be computed by a WTRU-to-NW relay according to one or more out-of-band computation instructions. Though the term 5G ProSe is used herein, one or more similar embodiment(s) may be implemented for ProSe communications in one or more other systems.

After the AMF stores 5G ProSe Authorized Information with the computation-integrated ProSe capability(ies) indication(s), for example, one or more other Network Function(s) (NFs) (e.g., 5G DDNMF) may retrieve 5G ProSe Authorized Information of a given WTRU and/or may search a WTRU that is authorized to support computation-integrated ProSe and/or may be in the proximity of a given WTRU.

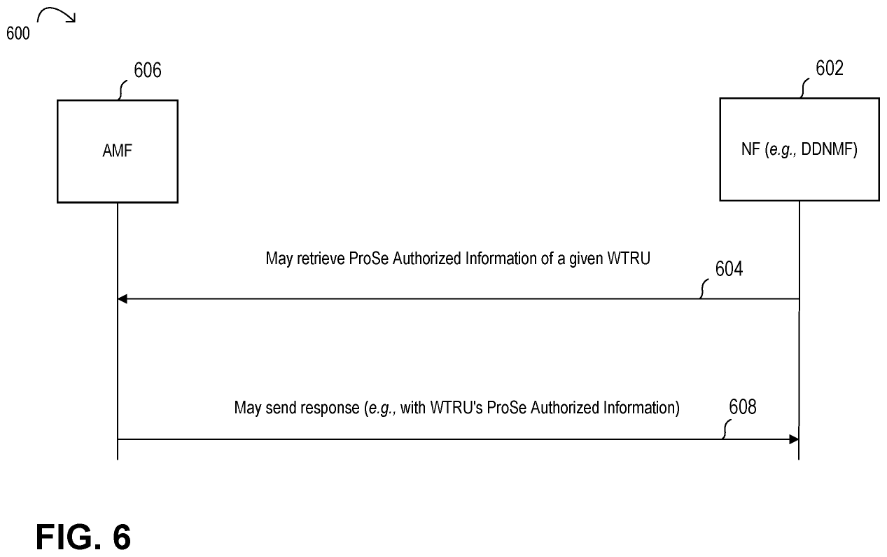

FIG. 6 illustrates a flow diagram that depicts an example of a procedure 600 for a NF to retrieve the authorized computation-integrated ProSe capability(ies) of a given WTRU.

At 604, the NF 602 may send a request to the AMF 606. The request 604 may indicate that the NF 602 wants to retrieve the authorized computation-integrated ProSe capability(ies) of a given WTRU. The request 604 may include the identifier of the WTRU. The request 604 may include a specific Computation Level and/or Computation Scope to indicate that the NF 602 (e.g., only) wants to retrieve the WTRU's authorized capability related to the specific Computation Level and/or Computation Scope. Additionally or alternatively, Computation Level, as described herein, may indicate one or more (e.g., simple) logical function(s), one or more (e.g., more complicated) functions and/or one or more filters.

The AMF 606 may look up its WTRU context database against the WTRU's identifier (e.g., and/or Computation Level and/or Computation Scope if included herein) and/or may find the WTRU's authorized computation-integrated ProSe capability.

At 608, the AMF 606 may send a response to the NF 602 including the found authorized computation-integrated ProSe capability of the WTRU. If the WTRU is not authorized to support and/or use any computation-integrated ProSe capability(ies), for example, the response may include an indication that the WTRU does not have any authorized computation-integrated ProSe capability and/or this response may (e.g., simply) include an empty message (e.g., the response may only include a header without any content body).

An Application Function (AF) (e.g., ProSe Application Server) may retrieve the WTRU's authorized computation-integrated ProSe capability(ies) from the AMF 606 directly (e.g., if the AF is trusted by 5GS) and/or indirectly via a Network Exposure Function (NEF), using the one or more similar (e.g., same) procedures as described herein.

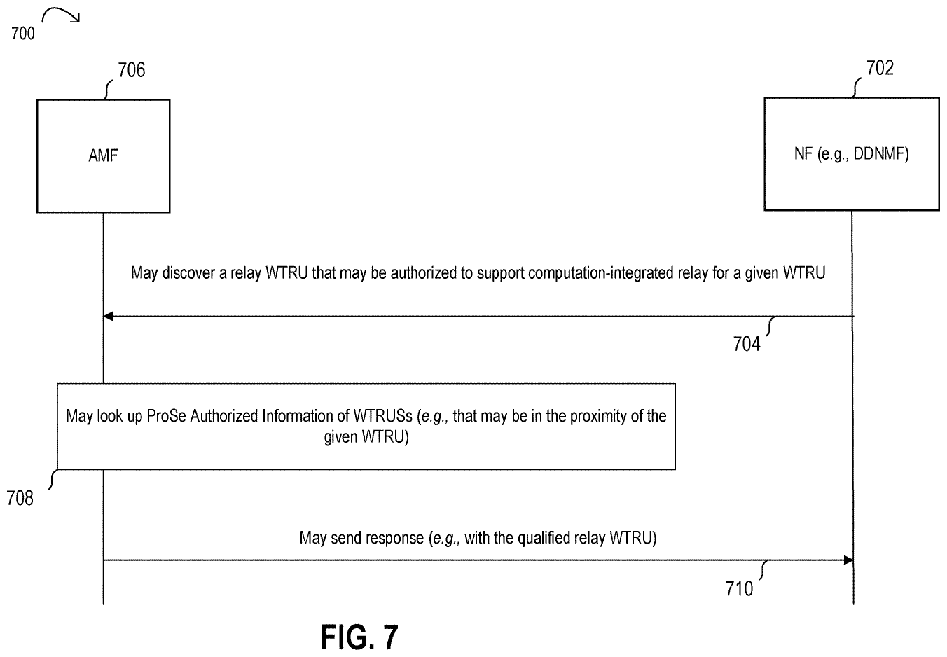

FIG. 7 illustrates a flow diagram that depicts an example of a procedure 700 for a NF to discover a relay WTRU with the authorized computation-integrated ProSe capability(ies) that may be within the proximity of a given WTRU.

At 704, the NF 702 may send a request to the AMF 706. The request may indicate that the NF 702 wants to discover a relay WTRU that meets one or more (e.g., some) of the relay WTRU condition(s). For example, the relay WTRU may be authorized to support computation-integrated ProSe capability (e.g., as requested). For example, the relay WTRU may be in the proximity of a given WTRU. For example, the relay WTRU may support one or more A/ML models and/or AI/ML functions (e.g., as described herein, AI/ML model 1209, 1209, and/or as described herein). As a result, for example, the request may include the identifier of the given WTRU and/or the requested computation-integrated ProSe capability(ies). The one or more relay WTRU condition(s) may be included, as described herein (e.g., included in the request). One or more other relay WTRU condition(s) may be specified by the NF 702 in its one or more future requests to the AMF 706. The NF 702 may dynamically indicate one or more other condition(s). For example, a NF 702 may (e.g., at any time) issue one or more other request(s) that indicate one or more different condition(s) (e.g., a different given WTRU, the relay WTRU should be in the proximity of multiple given WTRUs, etc.).

At 708, the AMF 706 may look up 5G Authorized ProSe Information of the one or more WTRU(s) that the AMF 706 maintain(s) their WTRU context against the one or more (e.g., two) conditions as described herein. The AMF 706 may find one or more (e.g., multiple) relay WTRU(s) that meet the one or more (e.g., two) condition(s), as described herein.

At 710, the AMF 706 may send a response to the NF 702. The response 710 may include the one or more identifier(s) of the one or more found relay WTRU(s), as described herein. The response 710 may include the WTRU's identifier. The NF 702 may have a task to select a relay WTRU for one or more (e.g., a few) remote WTRUs. If the NF 702 has the task to select a relay WTRU for one or more (e.g., a few) remote WTRUs, for example, the NF 702 may send the WTRU's identifier as the relay WTRU to the one or more remote WTRUs.

Procedures are described herein to discover helper WTRUs providing AI/ML application traffic support over device-to-device communication. Authorization and provisioning of AI/ML application operation parameters may be provided herein. The AI/ML AS may provision (e.g., over a PDU Session) AI/ML application operation specific parameter values for a parameter such as required PQI, a required time window, and/or specific geographical location (e.g., Tracking Area(s) and/or a Cell ID) The one or more parameters may be provisioned over the user plane supported, and/or associated to a specific application assistance operation mode (e.g., described herein, with respect to Table 1). Provisioning AI/ML application operation specific parameters may (e.g., explicitly) be set up for communication between the WTRU and the AIML AS. The one or more parameters may be provisioned in the mobile equipment (ME), configured in the Universal Integrated Circuit Card (UICC), and/or both, for example, through the PC1 reference point and/or via the PCF.

To help WTRU to determine whether to trigger discovery mechanism to find helper WTRUs, embodiments may include one or more operation modes associated to the context where the WTRU is authorized to use AI/ML application operation traffic helpers. For WTRU(s) capable of accessing AI/ML application operation enhancement(s) for device-to-device communications, one or more modes of operation (e.g., application assistance operation modes) may be described herein. The WTRU may use the application assistance operation mode and/or the associated configuration to trigger the discovery request (e.g., as Table 1 specifies). For example, the WTRU may trigger a ProSe discovery procedure indicating an application assistance operation mode and one or more ProSe capabilities. The WTRU may be configured to discover one or more AI and/or ML application assistance services (e.g., including one or more AI and/or ML application assistance services associated with AI/ML 1209 and/or 1209a as depicted in FIGS. 12A to 12C).

A WTRU may trigger a discovery request for a helper, for example, if one or more of the following conditions are met: if the WTRU is not being served by an NG-RAN; the WTRU requires to meet AI/ML application operation traffic demands according to PQI value=95; the WTRU is capable of supporting Prose Layer-3 WTRU-to-Network Relay (e.g., 5G Prose Layer-3 WTRU-to-Network Relay), supporting store and forward; and/or if the WTRU is authorized for this service while in certain location and/or public land mobile network (PLMN). A Relay Service Code may be associated to a WTRU that can support one or more (e.g., any) of the Prose Capabilities (e.g., for relay) that may be provided herein. The one or more ProSe Capabilities may include one or more AI/ML application assistance services associated with at least one or more of: data storage, data processing, and/or data aggregation at one or more peer WTRUs and/or one or more relay WTRUs.

The available application assistance operation modes may include Served-by-NG-RAN with WTRU-to-NW relaying support. The available application assistance operation modes may include Served-by-NG-RAN with WTRU peer support. The available application assistance operation modes may include Not-Served-by-NG-RAN with WTRU-to-NW relaying support. The available application assistance operation modes may include Not-Served-by-NG-RAN with WTRU peer support.

To determine the operation mode to use, the WTRU may receive provisioning information that associates an application assistance operation mode to a requirement from the AI/ML application operation traffic (e.g., in the form of a specific PQI value defined to support a guaranteed bit rate (GBR) with a specific delay budget and/or packet error rate) to run over the PC5 link (e.g., or any other application for that matter). Table 1 depicts, example associations of application assistance operation modes.

TABLE 1
Application Assistance Operation Modes

| Application | | | | |
|---|---|---|---|---|
| Assistance Operation | PQI | | Server Type | Location (e.g., TA or |
| Mode | Value | Prose Capability | (Edge/Cloud) | Geo coordinates) |
| Served-by-NG-RAN | 95 | 5G Prose Layer-3 UE-to- | Cloud | Tracking Area Identity |
| with UE-to-NW | | Network Relay, supporting | | (MCC1, MN1C, and/or |
| relaying support | | store and forward | | type allocation code |
| | | | | (TAC)1) |
| Served-by-NG-RAN | 98 | 5G Prose Direct | Cloud | Geographical location |
| with UE peer support | | Communication, | | close to AF Edge |
| | | supporting store and | | Server |
| | | forward | | |
| Not-Served-by-NG- | 99 | 5G Prose Layer-3 UE-to- | Edge | Cell ID1, Cell ID2, |
| RAN with UE-to-NW | | Network Relay, supporting | | PLMN1 |
| relaying support | | process and forward | | |
| Not-Served-by-NG- | 100 | 5G Prose Direct | Edge | Tracking Area Identity |
| RAN with UE peer | | Communication, | | (MCC2, MNC2, and/or |
| support | | supporting process and | | TAC2) |
| | | forward | | |

In addition to parameters for Prose Direct Discovery (e.g., 5G Prose Direct Discovery), the embodiments described herein may include Layer-2-IDs and/or Prose Discovery WTRU IDs (PDUIDs) that may be assigned to for WTRUs supporting capabilities, as described herein. The WTRU may use the one or more parameters (e.g., an associated Layer 2-ID), when performing as a helper WTRU to differentiate the traffic to be relayed and/or to be stored and forward or process and forwards.

Embodiments are described herein for discovery of AI/ML application operation helpers. For WTRU-to-Network relays, the User info ID may be enhanced to specify the mode of operation a WTRU may determine as being either volunteer-consumer and/or volunteer-provider. For example, a WTRU that wants to signal the WTRU's intent to perform as volunteer-producer WTRU may use a specific User Info ID satisfying this criterion (e.g., the intent a WTRU has to behave as volunteering-producer and/or volunteering-consumer). Additionally or alternatively, the Relay Service Code (RSC) may be enhanced and/or extended, and/or updated to also indicate a Helper Service Code (HSC) capability as follows. The RSC may be extended so that a WTRU performing as WTRU-to-Network relay may (e.g., also) be able to signal that can support (e.g., store and forward, process and forward, and/or both services) on top of its Layer 3 WTRU-to-Network relay services. The RSC may be extended so that one or more non relay WTRUs be able to indicate their capability to provide store and forward, process and forward, and/or both services.

The PDU Session parameters (e.g., single-network slice selection assistance information (S-NSSAI), data network name (DNN) may be associated to an HSC supporting a particular AI/ML application traffic characteristic. The WTRU that intends to provide volunteering-producer service(s) may use the PDU Session parameter(s) associated to this service. For example, a WTRU that intends to offer one or more volunteering-producer services may set up a PDU session set up on S-NSSAI and/or DNN that supports this service. Moreover, WTRUs that serve as volunteering-producer WTRUs, may (e.g., in turn) contact other volunteering-producer WTRUs (e.g., over a chain consisting of two peer WTRUs and/or one WTRU-to-Network Relay WTRU). A WTRU may use the extended RSC indicating store and forward services to (e.g., also) indicate that the WTRU can use the services of other WTRUs from the same Application Layer Group ID. The mechanism may be used to signal the availability of other services available at the relay WTRU (e.g., specific characteristics of the relay including extended reality (XR) and/or virtual reality (VR) capabilities).

Embodiments are described herein for a Prose Policy Provisioning request to support volunteering operations. A WTRU may trigger Policy Provisioning procedures to retrieve Prose Policies to enable the WTRU to find AI/ML application operation traffic helper WTRUs and/or to signal the WTRU's intent to provide volunteering-producer services for specific AI/ML application traffic. The PCF may use operator configured Prose parameters stored in the UDR and/or AF-based service parameter provisioning to obtain the relevant Prose parameters to be configured in the WTRU.

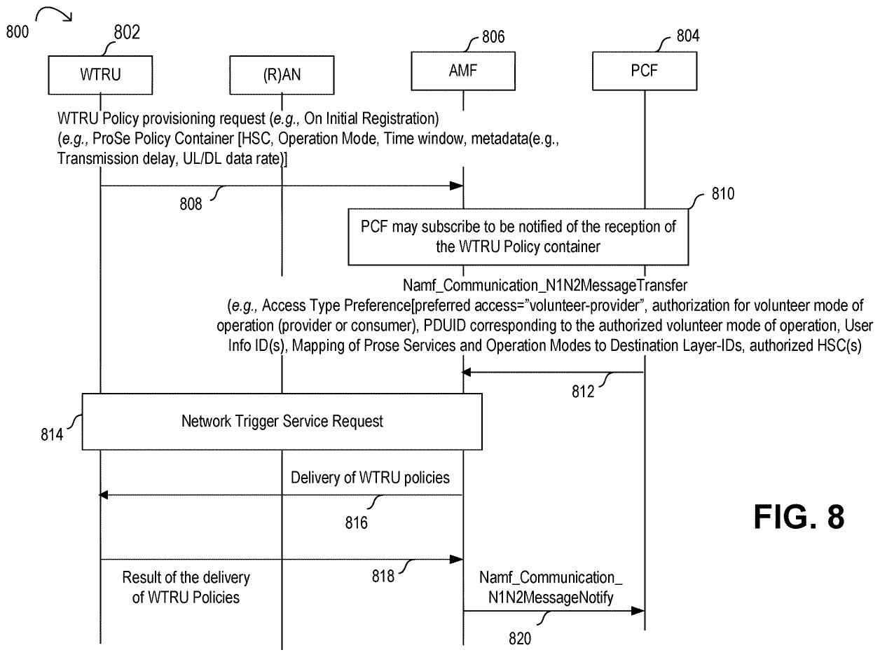

FIG. 8 illustrates and example Prose parameter provisioning 800.

At 808, the WTRU 802 may send a WTRU policy provisioning request to the AMF 806. The WTRU 802 may send the policy provisioning request 808 on initial registration. The policy provisioning request may indicate one or more ProSe capabilities (e.g., including one or more AI/ML 1209 application assistance services as described herein and/or with respect to AI/ML 1209, 1209a in FIGS. 12A to 12C). The policy provisioning request may include a ProSe Policy container. The ProSe Policy container may include one or more of: a HSC, an Operation mode, a time window, and/or metadata (e.g., transmission delay, UL/DL data rate, and/or the like). The procedure 800 may enable the WTRU 802 to signal, at 808, its intent to request one or more volunteering services (e.g., act as a volunteering-consumer) and/or to offer volunteering services (e.g., act as a volunteering-producer) by indicating the Helper Service Code, User Information identification (ID), and/or Operation Mode, along with a validity timer (e.g., time window) associated to Application ID the WTRU provides in the Policy Container and/or one or more QoS characteristics of the metadata specified by the WTRU such as Transmission delay and/or GFBR (e.g., QoS characteristics of a Vertical Federated Learning operation). For example, if the WTRU 802 intends to use Helper Services associated with Federated Learning (e.g., as described with respect to FIGS. 12A to 12C) and/or associated with how long specific model data is valid, the WTRU 802 may provide a time window where a request for a helper providing store and forward or a helper providing process and forward services may be valid.

At 810, the PCF 804 may receive the policy container from the AMF 806 and/or may derive the one or more services that can be enabled based on the information provided by the WTRU 802 in the Policy Container and/or the authorized services the WTRU 802 has in its subscriber record. Based on the requested operation mode and/or the QoS requirements of a service (e.g., Process and forward requirements) as requested by the WTRU 802, for example, the PCF 804 may determine the mode of operation (e.g., volunteer producer/volunteer consumer) and/or the associated PDUID corresponding to the authorized volunteering modes of operation. In examples, mapping of Prose services and/or HSC to Destination Layer-2 ID may be associated to the mode of operation for WTRU 802 that support store and forward and/or process and forward.

At 812, the PCF 804 may provide the policy container to the WTRU 802, for example, via the AMF 806 with the values as described herein. For example, the PCF 804 may send the AMF 806 Namf_Communication_N1N2Message Transfer (e.g., Access Type Preference [preferred access=“volunteer-provider”, authorization for volunteer mode of operation (provider or consumer), PDUID corresponding to the authorized volunteer mode of operation, User Info ID(s), Mapping of Prose Services and Operation Modes to Destination Layer-IDs, authorized HSC(s)).

At 814, one or more Network Triggered Service Request procedures may be initiated, for example, to deliver the policy.

At 816, delivery of one or more WTRU policies may take place using a WTRU Configuration Update Procedure. For example, the AMF 806 may send, at 816, the one or more WTRU policies to the WTRU 802.

At 818, the WTRU 802 may provide the result of the configured policies Layer Group ID. The WTRU 802 may send (e.g., at 818) the result of the delivery of one or more WTRU policies to the AMF 806. The AMF 806 may send (e.g., at 820) a message to the PCF 804. The message 820 may include Namf_Communication_N1N2MessageNotify. The message may include the result of the delivery of one or more WTRU policies.

Embodiments are described herein for a Prose Direct Discovery to support volunteering operations. A WTRU may be preconfigured to contact a DDNMF, for example, through a PDU established toward a specific DNN and/or S-NSSAI satisfying a specific AIML application. The WTRU may provide a Prose Application ID and/or operation mode and/or metadata supporting a specific operation mode, for example, to obtain discovery filters that correspond to Prose Application Codes and/or Prose Restriction Codes. For example, a WTRU may generate one or more discovery codes based on the one or more AI/ML application assistance services indicated by the one or more peer WTRUs and/or the one or more relay WTRUs during the ProSe discovery procedure.

The AI/ML application server (e.g., performing as a Prose Application Server) may negotiate with the DDNMF the AI/ML application operation codes to use for a specific AI/ML application operation type (e.g., this information may be provided in the form of metadata).

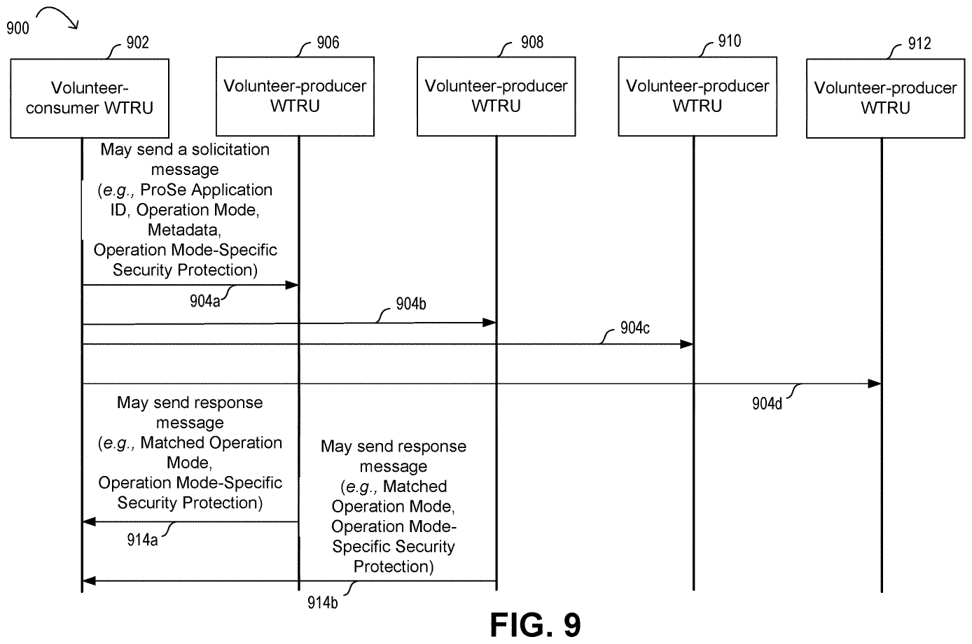

FIG. 9 illustrates a flow diagram that depicts an example ProSe Discovery Request 900 (e.g., Model B).

The Prose Discovery Request 900 depicts an example of how the Volunteer-consumer WTRU 902 may discover a (e.g., suitable) volunteer-provider WTRU by using a model B discovery procedure. As shown in FIG. 9, the WTRU 902 may provide the relevant mode of operation the WTRU 902 is looking for (e.g., whether the WTRU intent is to offer Volunteering-Producer services and/or requesting Volunteering-Consumer services) along with metadata associated to the operation mode (e.g., volunteer-provider, metadata supporting performance features to support model distribution). For example, the Volunteer-consumer WTRU 902 may provide one or more AI/ML models and/or AI/ML application assistance services (e.g., data aggregation, data processing, data storage, etc.), as described herein. Triggering the ProSe discovery may include sending, at 904a, 904b, 904c, 904d, a solicitation message to the one or more peer WTRUs and/or the one or more relay WTRUs using the one or more discovery codes. For example, the WTRU 902 may send one or more solicitation messages (e.g., at 904a, 904b, 904c, 904d) to one or more WTRU volunteer-producers (e.g., 906, 908, 910, 912). For example, the WTRU volunteer-consumer 902 may send, at 904a, a solicitation message to WTRU volunteer-producer 906. The WTRU volunteer-consumer 902 may send, at 904b, a solicitation message to WTRU volunteer-producer 908. The WTRU volunteer-consumer 902 may send, at 904c, a solicitation message to WTRU volunteer-producer 910. The WTRU volunteer-consumer 902 may send, at 904d, a solicitation message to WTRU volunteer-producer 912. The solicitation message may request one or more ProSe capabilities. The one or more ProSe capabilities may include store and forward and/or process and forward. The solicitation message may indicate a ProSe application identifier (ID), an operation mode, and/or metadata associated with the operation mode. For example, the WTRU, as part of the metadata associated to the operation mode, may indicate that the operation mode is, for example, vertical federated learning and/or that this service requires certain storage and processing capacity to be executed in a WTRU as acting as volunteering-producer. For example, the WTRU may indicate that the operation mode includes one or more supervised (e.g., neural network(s)) and/or unsupervised learning algorithms, as described herein. The WTRU may indicate the operation mode and/or AI/ML model(s) and/or AI/ML algorithms, as described herein (e.g., with respect to FIGS. 12A to 12C).

A volunteer WTRU (e.g., one of the volunteer-producer WTRUs 906, 908, 910, 912) may receive the solicitation message (e.g., 904a, 904b, 904c, and/or 904d). For example, the solicitation message may be a broadcast message. In examples, a volunteer WTRU (e.g., one of the volunteer-producer WTRUs 904a, 904b, 904c, and/or 904d) may use one or more discovery filters obtained from the DDNMF to match/associate the WTRU against the operation mode and/or metadata features (e.g., requirements). For example, a volunteer WTRU (e.g., a WTRU offering Volunteering-Producer services) may use one or more discovery filters to determine whether its processing capabilities and/or storage capacity can be matched against the specific requirements of, for example, a vertical federated learning operation specified in the metadata provided by the WTRU requesting one or more Volunteering-Producer services. For example, the volunteer-consumer WTRU 902 may generate one or more discovery codes based on the one or more AIML application assistance services associated with one or more of the volunteer-producer WTRUs 906, 908, 910, 912.

If the information provided in the discovery filters matches the request from the Volunteering-Consumer WTRU 902, the WTRU (e.g., the respective one of the volunteer-producer WTRUs 906, 908, 910, 912) may reply back to the Volunteering-Consumer WTRU 902. For example, at 914a, one of the volunteer-producer WTRUs (e.g., the WTRU volunteer-producer 906) may send a response message to the WTRU volunteer-consumer 902. The response message 914a may include one or more of: a matched operation mode, operation mode-specific security protection, and/or the like. For example, at 914b, another volunteer-producer WTRUs (e.g., the WTRU volunteer-producer 908) may send a response message to the WTRU volunteer-consumer 902. The response message 914b may include one or more of: a matched operation mode, operation mode-specific security protection, and/or the like. The WTRU (e.g., the volunteer-consumer WTRU 902) may receive a response message (e.g., 914a, 914b) from one or more of: the one or more peer WTRUs and/or the one or more relay WTRUs. The response message (e.g., 914a, 914b) may indicate that the respective WTRU is configured to perform a (e.g., first) ProSe capability requested in the solicitation message. For example, the response message (e.g., 914a, 914b) may indicate that the respective WTRU (e.g., volunteer-producer WTRU 906, 908, 910, 912) is configured to perform one or more AI/ML (e.g., AI/ML 1209, 1209a) functions, as described herein (e.g., as described herein, with respect to FIGS. 12A to 12C, and/or including supervised learning, unsupervised learning, includes neural networks, etc.).

Embodiments are described herein to enable WTRU-to-Network Relays (e.g., 5GS WTRU-to-Network Relays) to provide store/processing-and-forward capabilities. Prose-based connection establishment supporting AI/ML operation traffic may be described herein. The PDU Session parameters may be associated to an HSC supporting a particular AI/ML application traffic characteristic. The WTRU that intends to provide volunteering-producer services may use the PDU Session parameter associated to this service, which may include DNN, S-NSSAI, and/or possibly whether traffic over the PDU Session is subject to store and forward and/or process and forward treatment.

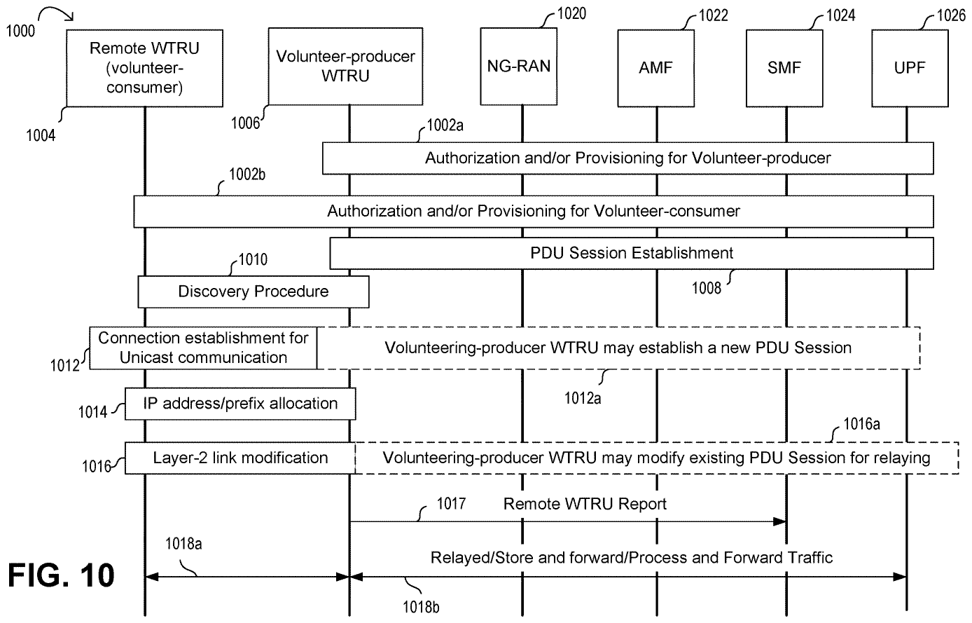

FIG. 10 illustrates, for example, the Prose Direct Communication supporting volunteering functionality procedure 1000.

As shown in FIG. 10, the Service authorization, provisioning, and/or discovery procedures (e.g., at 1002a, 1002b, 1008, and/or 1010) may be executed according to one or more mechanism(s) as described herein. For example, the User information ID may be enhanced to specify the mode of operation a WTRU may determine as being either a volunteer-consuming WTRU 1004 (e.g., such as the volunteer-consumer 902 shown in FIG. 9) or a volunteer-producer WTRU 1006 (e.g., such as one of the volunteer producers 906, 908, 910, 912 shown in FIG. 9). For example, a WTRU that wants to signal its intent to act as volunteer-producer WTRU may use a specific User information ID satisfying this criterion (e.g., to signal its intent to behave as volunteer-producer and/or volunteering-consumer WTRU).

At 1002a, authorization and/or provisioning may be performed for the volunteer-producer WTRU 1006. At 1002b, authorization and/or provisioning may be performed for the volunteer-consumer WTRU 1004. At 1008, a PDU session may be established between the volunteer producer WTRU 1006 and the network (e.g., a NG-RAN 1020, an AMF 1022, a SMF 1024, and/or an UPF 1026).

At 1010, a discovery procedure may be performed by the volunteer-consumer WTRU 1004 and/or the volunteer-producer WTRU 1006. For example, the volunteer-consumer WTRU 1004 may trigger, at 1010, the discovery procedure. The discovery procedure may include one or more procedures as depicted in and/or described with respect to FIG. 9 and/or as described herein. For example, the discovery procedure may include the WTRU volunteer-consumer WTRU 1004 sending (e.g., such as at 904a, at 904b, at 904c, and/or at 904d as shown in FIG. 9) a respective solicitation message to one or more WTRU volunteer-producers (e.g., such as volunteer-producers 906, 908, 910, and/or 912). The solicitation message may request one or more ProSe capabilities. For example, the solicitation message may indicate an application assistance operation mode and/or the one or more ProSe capabilities. The one or more ProSe capabilities may include store and forward and/or process and forward. The solicitation message may indicate a ProSe application identifier (ID), an operation mode (e.g., such as the application assistance operation mode), and/or metadata associated with the operation mode. For example, the volunteer-consumer WTRU 1004, as part of the metadata associated to the operation mode, may indicate that the operation mode is, for example, vertical federated learning and/or that this service requires certain storage and processing capacity to be executed in a WTRU as acting as volunteering-producer.

The volunteer-producer WTRU 1006 (e.g., one of the volunteer-producer WTRUs 906, 908, 910, 912) may receive the solicitation message (e.g., such as one of the volunteer-producer WTRUs 904a, 904b, 904c, and/or 904d). For example, the solicitation message may be a broadcast message. In examples, the volunteer-producer WTRU 1006 (e.g., such as one of the volunteer-producer WTRUs 904a, 904b, 904c, and/or 904d) may use one or more discovery filters obtained from the DDNMF to match/associate the volunteer-producer WTRU 1006 against the operation mode and/or metadata features (e.g., requirements). For example, the volunteer-producer WTRU 1006 (e.g., a WTRU offering Volunteering-Producer services) may use one or more discovery filters to determine whether its processing capabilities and/or storage capacity can be matched against the specific requirements of, for example, a vertical federated learning operation specified in the metadata provided by the volunteer-consumer WTRU 1004 requesting one or more Volunteering-Producer services. If the information provided in the discovery filters matches the request from the Volunteering-Consumer WTRU 1004, the volunteer-producer WTRU 1006 may reply back to the Volunteering-Consumer WTRU 1004. For example, the volunteer-producer WTRU 1006 may send, as part of the discovery procedure, a response message (e.g., such as at 914a shown in FIG. 9) to the volunteer-consumer WTRU 1004. The response message may include one or more of: a matched operation mode, operation mode-specific security protection, and/or the like. For example, the response message may indicate that the volunteer-producer WTRU 1006 is configured to perform a (e.g., first) ProSe capability requested in the solicitation message. For example, the response message (e.g., 914a, 914b) may indicate that the volunteer-producer WTRU 1006 (e.g., volunteer-producer WTRU 906, 908, 910, 912) is configured to perform one or more AI/ML functions (e.g., using an AI/ML model such as AI/ML 1209 shown in FIG. 12A and/or Neural Network 1209a shown in FIGS. 12B and 12C), as described herein (e.g., as described herein, with respect to FIGS. 12A to 12C, and/or including supervised learning, unsupervised learning, includes neural networks, etc.).

The volunteer-consumer WTRU 1004 may be configured to generate one or more discovery codes based on the one or more AI/ML functions supported by the volunteer-producer WTRU 1006.

At 1012, the volunteering-consumer WTRU 1004 may select a volunteering-producer WTRU 1006. The volunteering-consumer WTRU 1004 may determine, at 1012, an applicable Destination Layer-2 ID and/or a Helper Service Code to be used. For example, a first WTRU (e.g., the volunteer-consumer WTRU 1004) may select a second WTRU (e.g., the volunteering-producer WTRU 1006) from one or more peer WTRUs and/or one or more relay WTRUs based on one or more discovery codes, as described herein. Selecting the second WTRU may be based on a response message (e.g., such as the response messages 914a, 914b shown in FIG. 9) received, at 1010, during the discovery procedure, indicating the (e.g., first) ProSe capability, as described herein. For example, the Volunteer-consumer WTRU 1004 may select the volunteer-producer 1006 based on one or more ProSe capabilities associated with one or more AI/ML models and/or one or more AI/ML algorithms (e.g., such as AI/ML 1209 shown in FIG. 12A and/or the neural network 1209a shown in FIGS. 12B and 12C, etc.). In examples, additionally or alternatively, the volunteering-consumer WTRU 1004 may send, at 1012, a unicast Direct Communication Request also signalling the volunteering-consumer WTRU's intent to use store and forward and/or process and forward services from the volunteering-consumer WTRU 1004. For example, triggering ProSe direct communications may include the first WTRU sending a ProSe direct communication request to another (e.g., the second) WTRU that indicates an intent to use the (e.g., first) ProSe capability via the other (e.g., second) WTRU. The volunteer-producer WTRU 1006 may generate an associated Destination Layer-2 ID to be used for communications to transport store and forward and/or process and forward information, for example, based on the HSC. In examples, the main Layer-2 ID may be used for relaying functionality. The (e.g., first) WTRU may trigger ProSe direct communications with the selected (e.g., second) WTRU to enable the (e.g., first) WTRU to connect to the second WTRU for providing the one or more AI/ML application assistance services.

At 1012a, the Volunteering-Producer WTRU 1006 may establish a PDU Session using one or more PDU Session parameters (e.g., S-NSSAI, DNN) that may be associated to an HSC supporting a particular AI/ML application traffic characteristic. For example, the WTRU that intends to provide volunteering-producer services may use the PDU session parameter associated to this service. For example, a WTRU that intends to offer volunteering-producer services (e.g., such as volunteering-producer WTRU 1006) may set up a PDU Session set up on S-NSSAI and/or DNN that supports this service.

If the link layer is modified, for example, the WTRU (e.g., the volunteering-producer WTRU 1006) may request a PDU session modification procedure to set up another (e.g., new) QoS Flow and/or bind the traffic to an existing QoS Flow. From this point, for example, the uplink and/or the downlink relaying can start. For example, at 1014, an IP address/prefix may be allocated to the WTRU volunteer-consumer 1004 and WTRU volunteer-producer 1006. At 1016, the link layer may be modified (e.g., modification of layer-2 link modification). Modification of the link layer, at 1016, may include the volunteer-producer WTRU 1006 modifying, at 1016a, an existing PDU session, for example, for relaying.

At 1017, the volunteer-producer WTRU 1006 may send a message to the SMF 1024. The message may include a remote WTRU report. The remote WTRU report may include a remote WTRU user ID and/or IP address.

Depending on the selected Helper Service Code, for example, the WTRU-to-Network relay (e.g., the volunteer-producer WTRU 1006) may execute store and forward and/or process and forward operations (e.g., at 1018a, 1018b).

Embodiments are described herein for one or more procedures to enable (e.g., 5GS) assistance to AI/ML operations in the application layer for communication over PC5 link.

QoS monitoring for communications over PC5 links supporting AI/ML operations is described herein. The existing QoS monitoring assistance functionality that is supported may be included in QoS measurements of QoS parameters on QoS Flows supported over PDU Sessions, between WTRUs and AFs. QoS monitoring may be controlled by the PCF, based on PCF policies (e.g., authorized parameters to be measured). These policies may be delivered to the WTRU upon PDU session modification procedure, for example, if requested by an AF.

One or more performance statistics and/or predictions that may be used by the AI/ML application to determine whether the available resources are suitable to enable the successful execution of a specific AI/ML application operation may be (e.g., only) supported for connectivity over a PDU Sessions; the performance and/or prediction that these embodiments provide may be tailored to these types of connections.

Extending QoS monitoring functionality (e.g., also) for connection(s) over PC5 links may be described herein. Extending QoS monitoring functionality may include one or more of the following. Extending QoS monitoring functionality may enable the AF to request QoS monitoring for links between one or more (e.g., two) specific WTRUs, for a group to WTRU connected to the network through a specific WTRU-to-Network Relay and between one or more (e.g., two) WTRUs connected through a specific WTRU-to-WTRU Relay. Extending QoS monitoring functionality may enable the SMF and/or the NEF to request QoS measurements from (e.g., either) WTRUs directly, from the NG RAN, and/or from OAM entities. Extending QoS monitoring functionality may enable the NG RAN to provide QoS measurements on a per WTRU/PFI (PC5 QoS Flow Identifier).

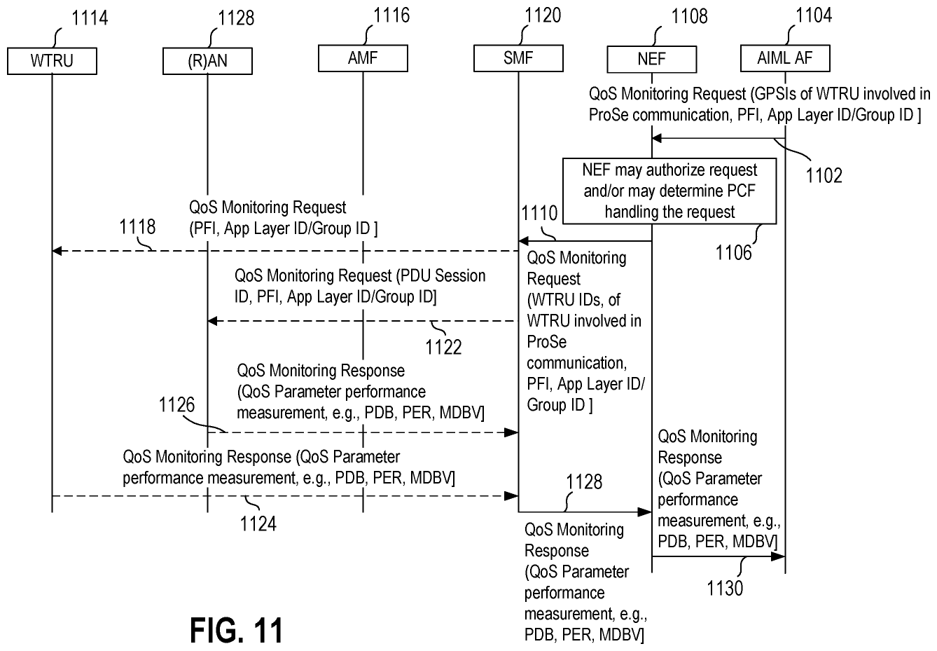

FIG. 11 depicts a flow chart diagram illustrating an example of QoS monitoring 1100 for PC5 links.

At 1102, the AF 1104 (e.g., an AI/ML application function) may request QoS monitoring for WTRUs that may be engaged in Proximity Service over a PC5 link. For example, the AF 1104 may send at 1102 a QoS monitoring request to the NEF 1108. The QoS monitoring request may include one or more GPSIs of WTRU(s) involved in ProSe communication, a PFI, and/or an application layer ID/group ID. The AF 1104 may (e.g., also) be connected to each one of the WTRUs via a PDU Session. The AF 1104 may use the Application ID, the Application Layer Group ID, Prose identifier, and/or the WTRU identities (e.g., generic public subscription identifiers (GPSIs) of the WTRU(s)) to request QoS monitoring for the WTRU using the application layer ID/Group ID over the PC5 link. Additionally or alternatively, if the AF 1104 is connected to these WTRU(s) over (e.g., regular) PDU Session, for example, the AF 1104 may obtain the PFI (PC5 QoS Flow Identifier) from one or more WTRUs the AF 1104 is interested in requesting QoS monitoring for PC5 communications and/or may use this PFI in the request towards the 5GS (e.g., towards the NEF). The AF 1104 may (e.g., also) use the Relay Service Code associated to a group of WTRU connected to a WTRU-to-Network Relay and/or associated to WTRU connected via WTRU-to-WTRU relay.

At 1106, the NEF 1108 may authorize the QoS monitoring requests and/or the NEF 1108 may (e.g., also) translate external identifier to one or more internal identifiers (e.g., GPSI to SUPI). The NEF 1108 may (e.g., also) use the WTRU ID(s) to identify the SMFs serving the WTRU for which QoS monitoring is being requested.

At 1110, the NEF 1108 may send (e.g., forward) the QoS monitoring request to one or more SMFs 1112 identified, as described herein. Additionally or alternatively, the NEF 1108 may send (e.g., forward) the request directly to the WTRU 1114 (e.g., via the AMF 1116) and/or through the PCF. The PCF may use QoS monitoring policies to determine the type of QoS monitoring that the AF may (e.g., is allowed) to request (e.g., reporting period, reporting when in certain locations, and/or reporting time window. The PCF and/or the NEF may determine to request QoS monitoring from the access network (e.g., the gNB) and/or from the WTRU, for example, based on one or more operator policies.

At 1118, the WTRU 1114 may receive a QoS monitoring request, for example from the SMF 1120. The QoS monitoring request may indicate to monitor one or more application traffic characteristics associated with an application assistance operation mode and/or one or more ProSe capabilities. The SMF 1120 may request QoS monitoring for one or more WTRU IDs requested by the AF 1104. The SMF 1120 may use the WTRU-ID to retrieve the SM context from the UDM and/or may derive the associated PDU sessions for those one or more WTRUs. The SMF 1120 may use the Application ID (e.g., Application Layer ID) and/or the Group ID and/or Prose Identifier and/or if provided by the AF 1114, the PFI, to signal the WTRU which PC5 links and/or which PC5 QoS flows may (e.g., may need) to be monitored, and/or what parameters need to be monitored. The SMF 1120 may use the authorized QoS policies provided by the PCF during the policy association procedure to construct the QoS monitoring request.

At 1122, additionally or alternatively, the SMF 1120 may request QoS monitoring from the eNB. The SMF 1120 may send a QoS monitoring request to the RAN 1128. The SMF 1120 may use the WTRU-ID to retrieve the SM context from the UDM and/or may derive the associated PDU session(s) for those WTRUs. The SMF 1120 may use the Application ID/Group ID and/or Prose identifier and/or if provided by the AF 1104, the PFI, to signal the gNB which PC5 links and/or which PC5 QoS flows may (e.g., may need) to be monitored, and/or what parameters may be (e.g., may need to be) monitored. The SMF 1120 may use the authorized QoS policies provided by the PCF during the Policy association procedure to construct the QoS monitoring request.

At 1124, the WTRU 1114 may send a QoS monitoring response to the SMF 1120, for example, in response to the QoS monitoring request received, at 1118. The QoS monitoring response may indicate one or more QoS monitoring results associated with the one or more application traffic characteristics (e.g., indicated by the QoS monitoring request). The QoS monitoring response may include one or more QoS parameter performance measurements (e.g., PDB, PER, MDBV, and/or the like). The WTRU 1114 may use the QoS monitoring policy and/or Prose identifier/Application ID/Group ID to identify the PC5 QoS flows that may (e.g., may need to be) monitored and/or what parameters may (e.g., may need to be) monitored from the QoS flows. For example, if the Prose identifier is associated to a vertical federating learning operation, that is running over a PC5 link using a specific PFI, the WTRU 1114 may monitor whether the allocated GMBR has crossed any threshold and/or may report it. The WTRU 1114 may use the Control Plane via NAS to report the monitoring results to the SMF 1120. Additionally or alternatively, the WTRU 1114 may use the application layer (e.g., using the Data collection function) to report the QoS monitoring results to a Data Collection Application Function from which the originally requesting AF 1104 (e.g., the AI/ML AF) may retrieve this data.

At 1126, additionally or alternatively, the RAN may send a QoS Monitoring response to the SMF 1120. The QoS monitoring response sent at 1126 may include one or more QoS parameter performance measurements (e.g., PDB, PER, MDBV, and/or the like). The gNB may use the QoS monitoring policy and Prose Identifier and/or Application ID and/or Group ID to identify the PC5 QoS flows that may (e.g., may need to) be monitored and/or what parameter(s) may (e.g., may need) to be monitored from the QoS flows (e.g., using the QoS monitoring policy). For example, if the Prose Identifier is associated to a vertical federated learning operation, that is running over a PC5 link using a specific PFI, the gNB may monitor whether the allocated GMBR has crossed any threshold and if so, report it. The eNB may use information received from the WTRU 1114 through the sidelink WTRU information NR message, to derive the QoS monitoring information requested by the AF 1104.

QoS measurement results may be forwarded to the AF 1104 via the NEF 1108. For example, the SMF 1120 may send, at 1128, a QoS monitoring response to the NEF 1108. The QoS monitoring response sent at 1128 may include one or more QoS parameter performance measurements (e.g., PDB, PER, MDBV, and/or the like). At 1130, the NEF 1108 may send a QoS monitoring response to the AF 1104 (e.g., AI/ML AF). The QoS monitoring response sent at 1130 may include one or more QoS parameter performance measurements (e.g., PDB, PER, MDBV, and/or the like). The QoS monitoring information may be based on the authorized QoS monitoring policies provided by the PCF, as described herein. For example, the AF 1104 may receive QoS monitoring information specifying whether a PC5 link is congested and/or is not meeting one or more QoS monitoring requirements. The AF 1104 may take the decision to no longer consider the one or more WTRUs that are part of a PC5 link communication for which QoS characteristics are no longer met.

FIG. 12A is a schematic illustration of an example system environment 1201 that may implement an AI/ML 1209 model. The AI/ML model 1209 may be implemented at the WTRU and/or the network (e.g., a location management function). The AI/ML 1209 model may include model data and one or more algorithms and/or functions configured to learn from input data 1207 that is received to train the AI/ML 1209 and/or generate an output 1215. The input data 1207 may be input in one or more formats, such as an image format, an audio format (e.g., spectrogram or other audio format), a tensor format (e.g., including single-dimensional or multi-dimensional arrays), and/or another data type capable of being input into the AI/ML 1209 algorithms. The input data 1207 may be the result of pre-processing 1205 that may be performed on raw data 1203, or the input data 1207 may include the raw data 1203 itself. The raw data 1203 may include image data, text data, audio data, or another sequence of information, such as a sequence of network information related to a communication network, and/or other types of data. The pre-processing 1205 may include format changes or other types of processing (e.g., averaging, filtering in time, and/or frequency domain) in order to generate input data 1207 in a format for being input into the AI/ML 1209 algorithms. The output 1215 may be generated by the AI/ML 1209 algorithm in one or more formats, such as a tensor, a text format (e.g., a word, sentence, or other sequence of text), a numerical format (e.g., a prediction), an audio format, an image format (e.g., including video format), another data sequence format, or/another output format.

AI/ML 1209 may be implemented as described herein using software and/or hardware. The AI/ML 1209 may be stored as computer-executable instructions on computer-readable media accessible by one or more processors for performing as described herein. Example AI/ML environments and/or libraries include TENSORFLOW, TORCH, PYTORCH, MATLAB, GOOGLE CLOUD AI and AUTOML, AMAZON SAGEMAKER, AZURE MACHINE LEARNING STUDIO, and/or ORACLE MACHINE LEARNING.

The AI/ML 1209 may include one or more algorithms configured for unsupervised learning. Unsupervised learning may be implemented utilizing AI/ML 1209 algorithms that learn from the input data 1207 without being trained toward a particular target output. For example, during unsupervised learning the AI/ML 1209 algorithms may receive unlabeled data as input data 1207 and determine patterns or similarities in the input data 1207 without additional intervention (e.g., updating parameters and/or hyperparameters). The AI/ML 1209 algorithms that are configured for implementing unsupervised learning may include algorithms configured for identifying patterns, groupings, clusters, anomalies, and/or similarities or other associations in the input data 1207. For example, the AI/ML may implement hierarchical clustering algorithms, k-means clustering algorithms, k nearest neighbors (K-NN) algorithms, anomaly detection algorithms, principal component analysis algorithms, and/or apriori algorithms. The AI/ML 1209 algorithms configured for unsupervised learning may be implemented on a single device or distributed across multiple devices, such that the output 1215, or portions thereof, may be aggregated at one or more devices for being further processed and/or implemented in other downstream algorithms or processes, as may be further described herein.

The AI/ML 1209 may include one or more algorithms configured for supervised learning. Supervised learning may be implemented utilizing AI/ML 1209 algorithms that are trained during a training process to determine a predictive model using known outcomes. The AI/ML 1209 algorithms may be characterized by parameters and/or hyperparameters that may be trained during the training process. The parameters may include values derived during the training process. The parameters may include weights, coefficients, and/or biases. The AI/ML 1209 may also include hyperparameters. The hyperparameters may include values used to control the learning process. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. Some may use certain parameters and hyperparameters interchangeably.

The AI/ML 1209 may be trained during supervised learning by inputting training data to the AI/ML 1209 algorithm and adjusting the parameters and/or hyperparameters toward a known target output 1215 while minimizing a loss or error in the output 1215 generated by the AI/ML 1209 algorithm. The raw data 1203 may include or be separated into training data, validation data, and/or test data for training, validation, and/or testing, respectively, the AI/ML 1209 algorithms during supervised learning. The training data, validation data, and/or test data may be pre-processed from the raw data 1203 for being input into the AI/ML 1209 algorithm. During supervised learning, the training data may be labeled prior to being input into the AI/ML 1209. The training data may be labeled to teach the AI/ML 1209 algorithm to learn from the labeled data and to test the accuracy of the AI/ML 1209 for being implemented on unlabeled input data 1207 during production/implementation of the AI/ML 1209 algorithms, or similar AI/ML 1209 algorithms utilizing similar parameters and/or hyperparameters. The training data may be used to fit the parameters of the AI/ML 1209 model using optimization functions, such as a loss or error function. Often the training data includes pairs of input data 1207 and a corresponding target output 1215 to which the parameters may be trained to generate (e.g., within a threshold loss or error). The trained or fitted AI/ML 1209 model may receive the validation data as input to evaluate the model fit on the training data set, while tuning the hyperparameters of the AI/ML 1209 model. The AI/ML 1209 model may receive the test data to evaluate a final model fit on the training data set and to assess the performance of the AI/ML 1209 model. One or more of the training, validation, and/or testing may be performed during supervised learning for different types of AI/ML 1209 models.

Supervised learning may be implemented for various types of AI/ML 1209 algorithms, including algorithms that implement linear regression, logistic regression, neural networks (NNs), decision trees, Bayesian logics, random forests, and/or support vector machines (SVMs). NNs and Deep NNs (DNNs) are popular examples of algorithms utilized in AI/ML models that may be trained using supervised learning. However, the AI/ML 209 models may implement one or more NN and/or non-NN-based algorithms. Various examples of NNs include: perceptrons, multilayer perceptrons (MLPs), feed-forward NNs, fully-connected NNs, convolutional Neural Networks (CNNs), recurrent NNs (RNNs), long-short term memory (LSTM) NNs, and/or residual NNs (ResNets). A perceptron is a NN that includes a function that multiplies its input by a learned weight coefficient to generate an output value. A feed-forward NN is a NN that receives input at one or more nodes of an input layer and moves information in a direction through one or more hidden layers to one or more nodes of an output layer. In a feed-forward NN, one or more nodes of a given layer may be connected to one or more nodes of another layer. A fully connected NN is a NN that includes an input layer, one or more hidden layers, and an output layer. In a fully connected NN, each node in a layer is connected to each node in another layer of the NN. An MLP is a fully connected class of feed-forward NNs. A CNN is a NN having one or more convolutional layers configured to perform a convolution. Various types of NNs may have elements that include one or more CNNs or convolutional layers, such as Generative Adversarial Networks (GANs). GANs may include conditional GANs (CGANs), cycle-consistent GANs (CycleGANs), StyleGANs, DiscoGANs, and/or IsGANs. A GAN may include a generator sub-model and a discriminator sub-model. The generator sub-model may be configured to receive input data and pass true and independently generated data to the discriminator sub-model. The discriminator sub-model may be configured to receive the true and independently generated data from the generator, discriminate the true and independently generated data, and provide feedback to the generator sub-model during training to improve the function of the generator sub-model in independently generating an output based on a received input. The GAN is a popular model for generating data types or data sequences, such as image data, audio data, and/or text, for example. An RNN is a NN that is recurrent in nature, as the nodes include feedback connections and an internal hidden state (e.g., memory) that allows output from nodes in the NN to affect subsequent input to the same nodes. LSTM NNs may be similar to RNNs in that the nodes have feedback connections and an internal hidden state (e.g., memory). However, the LSTM NNs may include additional gates to allow the LSTM NNs to learn longer-term dependencies between sequences of data. A ResNet is a NN that may include skip connections to skip one or more layers of the NN. An autoencoder may be a form of AI/ML 1209 that may be implemented for supervised learning, such that parameters and/or hyperparameters may be updated during a training procedure. The parameters and/or hyperparameters may relate to the encoder portion and/or the decoder portion of the autoencoder. Some NNs include one or more attention layers or functions to enhance or focus on some portions of the input data, while diminishing or de-emphasizing other portions.

Different types of NNs and/or layers may be implemented for processing different types of data and/or producing different types of output. For example, the NN may comprise one or more convolutional layers (e.g., for CNNs or GANs), which may be popular for processing image data and/or audio data (e.g., spectrograms). Each convolutional layer may vary according to various convolutional layer parameters or hyperparameters, such as kernel size (e.g., field of view of the convolution), stride (e.g., step size of the kernel when traversing an image), padding (e.g., for processing image borders), and/or input and output size. The image being processed may include one or more dimensions (e.g., a line of pixels or a two-dimensional array of pixels). The pixels may be represented according to one or more values (e.g., one or more integer values representing color and/or intensity) that may be received by the convolutional layer. The kernel, which may also be referred to as a convolution matrix or mask, may be a matrix used to extract and/or transform features from the input data being received. The kernel may be used for blurring, sharpening, edge detection, and/or the like. An example kernel size may include a 3×3, 5×5, 10×10, etc. matrix (e.g., in pixels for a 2D image). The stride may be the parameter used to identify the amount the kernel is moved over the image data. An example default stride is of a size of 1 or 2 within the matrix (e.g., in pixels for a 2D image). The padding may include the amount of data (e.g., in pixels for a 2D image) that is added to the boundaries of the image data when it is processed by the kernel. The kernel may be moved over the input image data (e.g., according to the stride length) and perform a dot product with the overlapping input region to obtain an activation value for the region. The output of each convolutional layer may be provided to a next layer of the NN or provided as an output (e.g., image data, feature map, etc.) of the NN itself with the updated features based on the convolution.

The NN may include layers of a similar type (e.g., convolutional layers, feed-forward layers, fully-connected layers, etc.) and/or having a similar or different configuration (e.g., size, number of nodes, etc.) for each layer. The NN may also, or alternatively, include one or more layers having different types or different subsets of NNs that may be interconnected for training and/or implementation, as described herein. For example, a NN may include both convolutional layers and feed-forward or fully-connected layers.

FIG. 12B illustrates an example of a neural network 1209a. The objective of training may be to apply the input 1207a as training data and/or adjust one or more weights, indicated as w and x in FIG. 12B (e.g., which may be referred to as neuron weights and/or link weights), such that the output 215 from the neural network 209a approaches the desired target values which are associated with the input 207a values for the training data. In examples, a neural network may include three layers (e.g., as shown in FIG. 12B). During the training, for given input, the difference between output and desired values may be computed and/or the difference may be used to update the one or more weights in the neural network. If a significant (e.g., large) difference between output and desired value(s) is observed, for example, one or more relatively significant (e.g., large) changes in one or more weights may be expected; a small difference (e.g., between output and desired value(s) may include one or more relatively small changes in one or more weights. For example, for positioning, the input 1207a may be reference signal parameters and/or the output 1215 may be an estimated position. The desired value may be location information acquired by global navigation satellite system (GNSS) with high accuracy.

Once the neural network 1209a completes its training, the difference between the output 1215 and desired values may be below a threshold. The neural network 1209a may be applied or implemented after training for positioning by feeding input data 1207a and/or by estimating or predicting the output 1215 as the expected outcome for the associated input 1207a. The output 1215 may be an estimated position and/or location of the WTRU.

Training a neural network 1209a may include identifying one or more of the following: the input for the neural network; the expected output associated with the input; and/or the actual output from the neural network against which the target values are compared.

In examples, a neural network model may be characterized by one or more parameters and/or hyperparameters, which may include: the number of weights and/or the number of layers in the neural network.

As used herein, the term “deep learning” may refer to a class of machine learning algorithms that employ artificial neural networks (e.g., deep neural networks (DNNs)) which were loosely inspired from biological systems and/or include at least one hidden layer. DNNs may be a special class of machine learning models inspired by the human brain where the input is linearly transformed and/or pass through a non-linear activation function one or more (e.g., multiple) times. DNNs may include one or more (e.g., multiple) layers where one or more (e.g., each) layer includes linear transformation and/or a given non-linear activation function(s). The DNNs may be trained using the training data via a back-propagation algorithm. Recently, DNNs have shown state-of-the-art performance in variety of domains, e.g., speech, vision, natural language etc., and/or for various machine learning settings (e.g., supervised, unsupervised, and/or semi-supervised).

FIG. 12C is a schematic illustration of an example system environment 1200 for training and implementing an AI/ML model that comprises an NN 1209a. However, other types of AI/ML models (e.g., including NNs and/or non-NN models) may be similarly trained and/or implemented. The NN 1209a may be trained and/or implemented on one or more devices to determine and/or update parameters and/or hyperparameters 1217 of the NN 1209a. Raw data 1203a may be generated from one or more sources. For example, the raw data 1203a may include image data, text data, audio data, or another sequence of information, such as a sequence of network information related to a communication network, and/or other types of data. The raw data 1203a may be preprocessed at 1205a (e.g., averaging, filtering in time, and/or frequency domain) to generate training data 1207a. The preprocessing may include formatting changes or other types of processing in order to generate the training data 1207a in a format for being input into the NN 1209a.

The NN 1209a may include one or more layers 1211. The configuration of the NN 209a and/or the layers 1211 may be based on the parameters and/or hyperparameters 1217. As described herein, the parameters may include weights, or coefficients, and/or biases for the nodes or functions in the layers 1211. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. As described herein, the NN 1209a may include a feed forward NN, a fully connected NN a CNN, a GAN, an RNN, a ResNet, and/or one or more other types of NNs. The NN 1209a may be comprised of one or more different types of NNs or different layers for different types of NNs. For example, the NN 1209a may include one or more individual layers having one or more configurations.

During the training process, the training data 1207a may be input into the NN 1209a and may be used to learn the parameters and/or tune the hyperparameters 1217. The training may be performed by initializing parameters and/or hyperparameters of the NN 1209a, generating and/or accessing the training data 207a, inputting the training data 1207a into the NN 1209a, calculating the error or loss from the output of the NN 1209a to a target output 1215a via a loss function 1213 (e.g., utilizing gradient descent and/or associated back propagation), and/or updating the parameters and/or hyperparameters 1217.

The loss function 1213 may be implemented using backpropagation-based gradient updates and/or gradient descent techniques, such as Stochastic Gradient Descent (SGD), synchronous SGD, asynchronous SGD, batch gradient descent, and/or mini-batch gradient descent. Examples of loss or error functions may include functions for determining a squared-error loss, a mean squared error (MSE) loss, a mean absolute error loss, a mean absolute percentage error loss, a mean squared logarithmic error loss, a pixel-based loss, a pixel-wise loss, a cross-entropy loss, a log loss, and/or a fiducial-based loss. The loss functions may be implemented in accordance with one or more quality metrics, such as a Signal to Noise Ratio (SNR) metric or another signal or image quality metric.

An optimizer may be implemented along with the loss function 1213. The optimizer may be an algorithm or function that is configured to adapt attributes of the NN 1209a, such as a learning rate and/or weights, to improve the accuracy of the NN 1209a and/or reduce the loss or error. The optimizer may be implemented to update the parameters and/or hyperparameters 1217 of the NN 1209a.

The training process may be iterated to update the parameters and/or hyperparameters 1217 until an end condition is achieved. The end condition may be achieved when the output of the NN 209a is within a predefined threshold of the target output 1215a.

After the training process is complete, the trained NN 1209a, or portions thereof, may be stored for being implemented by one or more devices. The trained NN 1209a, or portions thereof, may be implemented in other downstream algorithms or processes, as may be further described herein. The trained NN 1209a, or portions thereof, may be implemented on the same device on which the training was performed. The trained NN 1209a, or portions thereof, may be transmitted or otherwise provided to another device for being implemented. For example, the NN 1209b, 1209c may include one or more portions of the trained NN 1209a. The NN 1209b and NN 1209c receive respective input data 1207b, 1207c and generate respective outputs 1215b, 1215c. The output 1215b, 1215c may be generated in one or more formats, such as a tensor, a text format (e.g., a word, sentence, or other sequence of text), a numerical format (e.g., a prediction), an audio format, an image format (e.g., including video format), another data sequence format, and/or another output format. The output 1215b, 1215c may be aggregated at one or more devices for being further processed and/or implemented in other downstream algorithms or processes, as may be further described herein.

Alternatively, or additionally, after the training process is complete, the trained parameters and/or tuned hyperparameters 1217, or portions thereof, may be stored for being implemented by one or more devices. The trained parameters and/or tuned hyperparameters 1217, or portions thereof, may be implemented in other downstream algorithms or processes, as may be further described herein. The trained parameters and/or tuned hyperparameters 1217, or portions thereof, may be implemented on the same device on which the training was performed. The trained parameters and/or tuned hyperparameters 1217, or portions thereof, may be transmitted or otherwise provided to another device for being implemented. For example, transmitted or otherwise provided to another device or devices that may implement the NN 1209b, 1209c based on the trained parameters and/or tuned hyperparameters 1217. For example, the NN 1209b, 1209c may be constructed at another device based on the trained parameters and/or tuned hyperparameters 217, or portions thereof. The NN 1209b and NN 1209c may be configured from the parameters/hyperparameters 1217, or portions thereof, to receive respective input data 207b, 207c and to generate respective outputs 1215b, 1215c. The output 1215b, 1215c may be generated in one or more formats, such as a tensor, a text format (e.g., a word, sentence, or other sequence of text), a numerical format (e.g., a prediction), an audio format, an image format (e.g., including video format), another data sequence format, and/or another output format. The output 1215b, 1215c may be aggregated at one or more devices for being further processed and/or implemented in other downstream algorithms or processes, as may be further described herein.

The AI/ML models and/or algorithms described herein may be implemented on one or more devices. For example, the AI/ML 1209 may be implemented in whole or in part on one or more devices, such as one or more WTRUs, one or more base stations, and/or one or more other network entities, such as a network server. Example networks in which AI/ML may be distributed may include federated networks. A federated network may include a decentralized group of devices that each include AI/ML. As shown in FIG. 12, the AI/ML 1209b and AI/ML 1209c may be distributed across separate devices. Though FIG. 12 shows two models (e.g., AI/ML 1209b and AI/ML 1209c), any number of models may be implemented across any number of devices. The AI/ML may be implemented for collaborative learning in which the AI/ML is trained across multiple devices. In another example, the AI/ML may be trained at a centralized location or device and one or more portions of the AI/ML, or trained parameters and/or tuned hyperparameters, may be distributed to decentralized locations. For example, updated parameters or hyperparameters may be sent to one or more devices for updating and/or implementing the AI/ML thereon.

AI/ML may be used to estimate positioning (e.g., location of the WTRU). For example, a WTRU and/or network may use AI/ML to estimate positioning (e.g., location of the WTRU). A WTRU and/or network may estimate positioning based on one or more measurements (e.g., one or more measurements made on received PRSs transmitted from one or more TRPs and/or based on the location of one or more TRPs). For example, the WTRU and/or network may train an AI/ML model, as described herein, based on one or more actual and/or estimated measurements. As used herein, the term network may include application management function (AMF), location management function (LMF), base station (e.g., gNB), and/or next-generation radio access network (NG-RAN).

What is claimed is:

1-20. (canceled)

21. A first wireless transmit/receive unit (WTRU) comprising:
a processor configured to:
receive configuration information to initiate a proximity services (ProSe) discovery procedure, wherein the configuration information comprises ProSe capability information to select a second WTRU, wherein the ProSe capability information comprises one or more artificial intelligence machine learning (AIML) application assistance services associated with one or more peer WTRUs or one or more relay WTRUs;
initiate the ProSe discovery procedure to discover the one or more peer WTRUs or the one or more relay WTRUs;
generate one or more discovery codes based on the one or more AIML application assistance services associated with the one or more peer WTRUs or the one or more relay WTRUs during the ProSe discovery procedure;
select the second WTRU from the one or more peer WTRUs or the one or more relay WTRUs based on one or more discovery codes associated with the second WTRU, and wherein the second WTRU is selected based on a determination that the second WTRU is configured to perform the one or more AIML application assistance services; and
perform a ProSe direct communication procedure with the selected second WTRU to establish a connection between the first WTRU and the second WTRU to provide the one or more AIML application assistance services.

22. The first WTRU of claim 21, wherein the processor is configured to send a solicitation message to the one or more peer WTRUs or the one or more relay WTRUs using the one or more discovery codes, wherein the solicitation message comprises a request for a first ProSe capability of the ProSe capability information.

23. The first WTRU of claim 22, wherein the processor is configured to receive a response message from one or more of the one or more peer WTRUs or the one or more relay WTRUs, wherein the response message indicates whether each respective WTRU is configured to perform the first ProSe capability requested in the solicitation message.

24. The first WTRU of claim 23, wherein the first ProSe capability comprises 1) store and forward or 2) process and forward.

25. The first WTRU of claim 23, wherein the processor is configured to select the second WTRU based on the response message indicating the first ProSe capability.

26. The first WTRU of claim 22, wherein the solicitation message indicates one or more of: a ProSe application identifier (ID), an application assistance operation mode, or metadata associated with the application assistance operation mode.

27. The first WTRU of claim 22, wherein the processor is configured to send a ProSe direct communication request to the second WTRU, that indicates an intent to use the first ProSe capability via the second WTRU, to perform the ProSe direct communications procedure.

28. The first WTRU of claim 21, wherein the configuration information comprises an application assistance operation mode, and wherein the application assistance operation mode or the ProSe capability information is associated with one or more AI or ML applications, and wherein the AIML application assistance services comprise one or more of: data storage, data processing, or data aggregation at the one or more peer WTRUs or at the one or more relay WTRUs.

29. The first WTRU of claim 21, wherein the processor is configured to send a provisioning request, wherein the provisioning request indicates the ProSe capability information, and wherein the provisioning request comprises one or more of: a helper service code, a user information identification (ID), an application assistance operation mode, or one or more quality of service (QoS) characteristics.

30. The first WTRU of claim 21, wherein the processor is configured to:
receive a quality of service (QoS) monitoring request that indicates to monitor one or more application traffic characteristics associated with the application assistance operation mode or the ProSe capability information; and
send a QoS monitoring response that indicates one or more QoS monitoring results associated with the one or more application traffic characteristics.

31. A method performed by a first wireless transmit/receive unit (WTRU), the method comprising:
receiving configuration information to initiate a proximity services (ProSe) discovery procedure, wherein the configuration information comprises ProSe capability information to select a second WTRU, wherein the ProSe capability information comprises one or more artificial intelligence machine learning (AIML) application assistance services associated with one or more peer WTRUs or one or more relay WTRUs;
initiating the ProSe discovery procedure to discover the one or more peer WTRUs or the one or more relay WTRUs;
generating one or more discovery codes based on the one or more AIML application assistance services associated with the one or more peer WTRUs or the one or more relay WTRUs during the ProSe discovery procedure;
selecting the second WTRU from the one or more peer WTRUs or the one or more relay WTRUs based on one or more discovery codes associated with the second WTRU, and wherein the second WTRU is selected based on a determination that the second WTRU is configured to perform the one or more AIML application assistance services; and
performing a ProSe direct communication procedure with the selected second WTRU to establish a connection between the first WTRU and the second WTRU to provide the one or more AIML application assistance services.

32. The method of claim 31, further comprising sending a solicitation message to the one or more peer WTRUs or the one or more relay WTRUs using the one or more discovery codes, wherein the solicitation message comprises a request for a first ProSe capability of the ProSe capability information.

33. The method of claim 32, further comprising receiving a response message from one or more of the one or more peer WTRUs or the one or more relay WTRUs, wherein the response message indicates whether each respective WTRU is configured to perform the first ProSe capability requested in the solicitation message.

34. The method of claim 33, wherein the first ProSe capability comprises 1) store and forward or 2) process and forward.

35. The method of claim 33, further comprising selecting the second WTRU based on the response message indicating the first ProSe capability.

36. The method of claim 32, wherein the solicitation message indicates one or more of: a ProSe application identifier (ID), an application assistance operation mode, or metadata associated with the application assistance operation mode.

37. The method of claim 32, further comprising sending a ProSe direct communication request to the second WTRU, that indicates an intent to use the first ProSe capability via the second WTRU, to perform the ProSe direct communications procedure.

38. The method of claim 31, wherein the configuration information comprises an application assistance operation mode, and wherein the application assistance operation mode or the ProSe capability information is associated with one or more AI or ML applications, and wherein the AIML application assistance services comprise one or more of: data storage, data processing, or data aggregation at the one or more peer WTRUs or at the one or more relay WTRUs.

39. The method of claim 31, further comprising sending a provisioning request, wherein the provisioning request indicates the ProSe capability information, and wherein the provisioning request comprises one or more of: a helper service code, a user information identification (ID), an application assistance operation mode, or one or more quality of service (QoS) characteristics.

40. The method of claim 31, further comprising:
receiving a quality of service (QoS) monitoring request that indicates to monitor one or more application traffic characteristics associated with the application assistance operation mode or the ProSe capability information; and
sending a QoS monitoring response that indicates one or more QoS monitoring results associated with the one or more application traffic characteristics.
